(19) United States
(12) Patent Application Publication
(10) Pub. No.: US 2009/0055205 A1
(43) Pub. Date: Feb. 26, 2009

(54) MULTIMEDIA PLAYER TRACKING INFRASTRUCTURE

(75) Inventors: Binh T. Nguyen, Reno, NV (US); Brian Underdahl, VC Highlands, NV (US)

Correspondence Address: Weaver Austin Villeneuve & Sampson LLP - IGT;Attn: IGT, P.O. Box 70250, Oakland, CA, 94612-0250, US

(73) Assignee: IGT

(21) Appl. No.: 11/844,267

(22) Filed: Aug. 23, 2007

(51) Int. Cl. H04N 5/232; G06K 9/62; G06Q 10/00

(52) U.S. Cl. 705/1; 348/169; 382/103

(57) ABSTRACT

Some implementations of the invention provide methods, devices and systems for acquiring patron data in real time. A plurality of networked cameras may be used to acquire information regarding casino patrons. The cameras may include “smart cameras” having an integrated machine vision system. The real-time information may be used to populate one or more databases of a player loyalty program. Patron information may also be used to determine trends associated with patron demographics, with levels of a player loyalty program, etc. Some implementations of the invention involve monitoring patron event data and determining when predetermined events of interest occur. When a defined event occurs, patron data relating to the associated patron may be monitored, analyzed and used to populate one or more player loyalty databases. In some implementations, patron data acquired prior to the time of the defined event may also be analyzed and used.

### CROSS-REFERENCE TO RELATED APPLICATION

This application is related to U.S. patent application Ser. No. ______, filed on Aug. 23, 2007 and entitled, “Real-Time Player Tracking” (Attorney Docket No. IGT1P399/P-1206), which is hereby incorporated by reference.

### FIELD OF THE INVENTION

The present invention relates generally to player tracking services and systems.

### BACKGROUND OF THE INVENTION

Player tracking programs (also known as player loyalty programs) are offered at gaming establishments for various reasons, including the desire to attain and/or maintain a player's interest in game play. (Although there are many types of gaming establishments, including casinos, cruise ships, riverboats, etc., all types of gaming establishments may be referred to herein as “casinos.”) Player tracking programs provide rewards to players that typically correspond to the player's level of patronage, e.g., to the player's playing frequency and/or total amount of game plays at a given casino. Player tracking rewards may include free meals, free lodging and/or free entertainment. Some such complimentary rewards are often referred to as “comps.” Player tracking rewards may help to sustain a game player's interest in additional game play during a visit to a gaming establishment and may entice a player to visit a gaming establishment to partake in various gaming activities.

Player tracking programs may be applied to any game of chance offered at a gaming establishment. In particular, player tracking programs are very popular with players of mechanical slot gaming machines and video slot gaming machines. In a gaming machine, a player tracking program may be implemented using a player tracking unit installed in the gaming machine and in communication with a remote player tracking server.

Casinos may use player loyalty programs to gather information regarding patrons that may be used for marketing and provide better customer services. In particular, casinos generally seek to identify certain groups of patrons identified as especially valuable to the casinos and to provide a higher level of service to such patrons. Therefore, player loyalty programs have become important marketing and customer relations tools for casinos.

Casinos may also use player loyalty programs to generate “brand” loyalty. Such loyalty may arise due to the fact that the programs allow a casino to identify and reward patrons based upon their previous game play history. Moreover, after accumulating points in a casino's player loyalty program, patrons may feel that they have made an investment of time and money that will continue to reap benefits if they continue to patronize the casino.

Gaming establishments are continually searching for new and innovative techniques to track patron activity to improve casino operations and marketing. Prior art player loyalty systems have limitations, e.g., regarding a casino's ability to profile players, analyze trends and determine incentives that will build player loyalty. It would be desirable to provide more versatile player tracking methods and devices.

### SUMMARY OF THE INVENTION

Some implementations of the invention provide methods, devices and systems for acquiring patron data in real time. For example, a plurality of networked cameras may be used to acquire information regarding casino patrons. In some such embodiments, some or all cameras in the network may be “smart cameras” that include an integrated machine vision system or the like.

The real-time information may be used to populate one or more databases of a player loyalty program. Some such information may be associated with individual patrons and may, for example, be associated with a member of a player loyalty program. Patron information may also be used to determine trends associated with patron demographics, with levels of a player loyalty program, etc.

Some implementations of the invention involve monitoring patron event data and determining when predetermined events of interest occur. A predetermined event may be referred to herein as a “defined event” or the like. The defined event may involve a certain wagering and/or “coin in” level, the insertion of a player loyalty card into a wager gaming machine, etc. Accordingly, the defined event may or may not be associated with a patron who is known to be member of a player loyalty program. According to some such implementations, when a defined event occurs, patron data relating to the associated patron may be monitored, analyzed and used to populate one or more player loyalty databases. In some implementations, patron data acquired prior to the time of the defined event may also be analyzed.

Some embodiments of the invention provide a system for providing gaming services. The system comprises a plurality of cameras for obtaining patron data regarding patrons in or near a gaming establishment. The cameras are configured for communication with other devices via a network. The system may also include at least one server comprising the following elements: at least one network interface configured for communication with the network; a memory system comprising at least one memory device having a rule set of defined events stored thereon; and a logic system. The logic system may include one or more logic devices, such as processors, programmable logic devices or the like. The logic system may be configured to do the following: acquire video data from at least one of the cameras via the network interface, the video data comprising patron data; determine, with reference to the rule set, whether the patron data comprise defined event data; and categorize patrons according to the determination.

Some systems of the invention include a plurality of servers and/or other devices that can provide functions such as player loyalty functions, player identification functions, player location functions, storage and retrieval of real-time player tracking data, etc. Device functionality may be apportioned by grouping or dividing tasks in any convenient fashion. Therefore, when steps are described herein as being performed by a single device (e.g., a single server), the steps may alternatively be performed by multiple devices and vice versa.

The system may comprise apparatus configured for tracking a patron who moves from a first field of view of a first camera to a second field of view of a second camera. At least some cameras may be configured for automated patron tracking. Some such cameras may be “smart cameras” or the like. The logic system may be further configured to determine when to hand off tracking of a patron from a first camera to a second camera. Alternatively, another device may be so configured, e.g., a smart camera, a host device, etc. The logic system (or another device) may be further configured to determine a patron location.

The logic system may be further configured to receive descriptive data regarding a patron and associate the descriptive data with the video data. In some such implementations, the logic system may associate the descriptive data with the video data according to the MPEG-7 standard or the like. At least some cameras (or other devices) may be configured to determine whether the patron data comprise defined event data. Devices of the system (such as host devices, cameras, servers, etc.) may be configured to automatically generate descriptive data according to patron data. The descriptive data may relate to defined events.

The logic system (or another device) may be further configured to determine a characteristic display type for a patron category. For example, a particular patron category or rank may be associated with (and/or displayed in) a particular color and/or pattern.

The system preferably includes at least one host device (such as a personal digital assistant (“PDA”), a personal computer, a laptop computer, etc.) configured for communication with the network. Such a host device may be configured to display video data from at least one camera. The host device may be configured to display patrons according to patron categories. The host device may be configured to display a patron according a characteristic color or shape associated with a patron category. The host device may be configured to receive an indication of a selected patron from a user.

The host device may also be configured to receive an indication to view previously-acquired patron data regarding the selected patron and to transmit a request to view the previously-acquired patron data to a server, which may or may not be the previously-described server. The server may be further configured to receive the request, to retrieve previously-acquired patron data for the selected patron and to transmit the previously-acquired patron data to the host device. The previously-acquired patron data may comprise video data, descriptive data and/or patron location data.

Alternative systems for providing gaming services are also described herein. Some such systems comprise a plurality of cameras for obtaining patron data regarding people in or near a gaming establishment. The patron data may comprise image data, including but not limited to facial image data. At least some of the cameras may comprise smart cameras configured for automatically tracking patrons. The cameras may be configured for communication with other devices via a network.

The system may also include at least one server comprising at least one network interface configured for communication with the network and a logic system. The logic system may include one or more logic devices, such as processors, programmable logic devices or the like. The logic system may be configured to do the following: acquire patron data regarding a patron from at least one of the cameras via the network interface; categorize the person with reference to the acquired patron data; and determine whether to provide a benefit to the person according to a categorization.

The logic system may be further configured to obtain stored patron data regarding the patron from a database and categorize the patron with reference to the acquired patron data and the stored patron data. The database may be, for example, a player loyalty system database.

The logic system may be configured to determine the patron's expected economic value to the gaming establishment. The person may be categorized, at least in part, according to the expected economic value. The logic system may assign a rank to the patron. The rank may depending at least in part on the patron's expected economic value to the gaming establishment.

The system may further comprise apparatus for tracking the patron's location while the person is within, or in the vicinity of, the gaming establishment. The tracking apparatus may comprise apparatus for communicating the person's location via the network. The tracking apparatus may comprise apparatus for handing off acquired patron data from a first range of a first camera to a second range of a second camera. The tracking apparatus may comprise one or more components of a radio frequency identification (“RFID”) network.

Some implementations of the invention involve methods of providing gaming services. Some such methods include these steps: acquiring image data of people in or near a gaming establishment; analyzing the image data according to a first rule set; determining whether a person is a member of a player loyalty program; and analyzing the image data according to a second rule set when it is determined that the person is a member of the player loyalty program. For example, the player loyalty system may comprise a card-based player tracking system and the determining step may comprise determining when the person's player loyalty card has been inserted into a wager gaming machine. The method may involve tracking the person's location while the person is within, or in the vicinity of, the gaming establishment.

At least one of the rule sets may involve one or more of wagering indicia, clothing indicia, jewelry indicia, personal association indicia, tipping indicia and purchasing indicia. The step of analyzing the image data according to the second rule set may involve a more detailed analysis of stored image data acquired prior to a time at which it was determined that the person is a member of the player loyalty program.

### BRIEF DESCRIPTION OF THE DRAWINGS

FIG. 1A depicts an example of a gaming establishment and related devices that may be used for some implementations of the invention.

FIG. 1B depicts an example of an alternative gaming establishment and related devices that may be used for some implementations of the invention.

FIG. 1C depicts an example of a portion of a gaming establishment and related devices that may be used for alternative implementations of the invention.

FIG. 1D depicts a simplified example of a portion of a gaming establishment and related devices that may be used for other implementations of the invention.

FIG. 2 is flow chart that outlines steps of some methods of the invention.

FIGS. 3A through 3G depict examples of graphical user interfaces that may be used for some implementations of the invention.

FIGS. 4A and 4B provide examples of how descriptive information may be associated with audiovisual data.

FIG. 5 is a flow chart that outlines a method of the invention.

FIG. 6 is a flow chart that outlines another method of the invention.

FIG. 7 is a table that indicates one example of ranking and categorizing patrons.

FIG. 8 is a flow chart that outlines another method of the invention.

FIG. 9 illustrates a gaming network that may be used for some implementations of the invention.

FIG. 10 is a block diagram of an Arbiter and other devices that may be used for some implementations of the invention.

FIG. 11 is a diagram of a server that may be configured according to some implementations of the invention.

### DESCRIPTION OF THE PREFERRED EMBODIMENTS

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

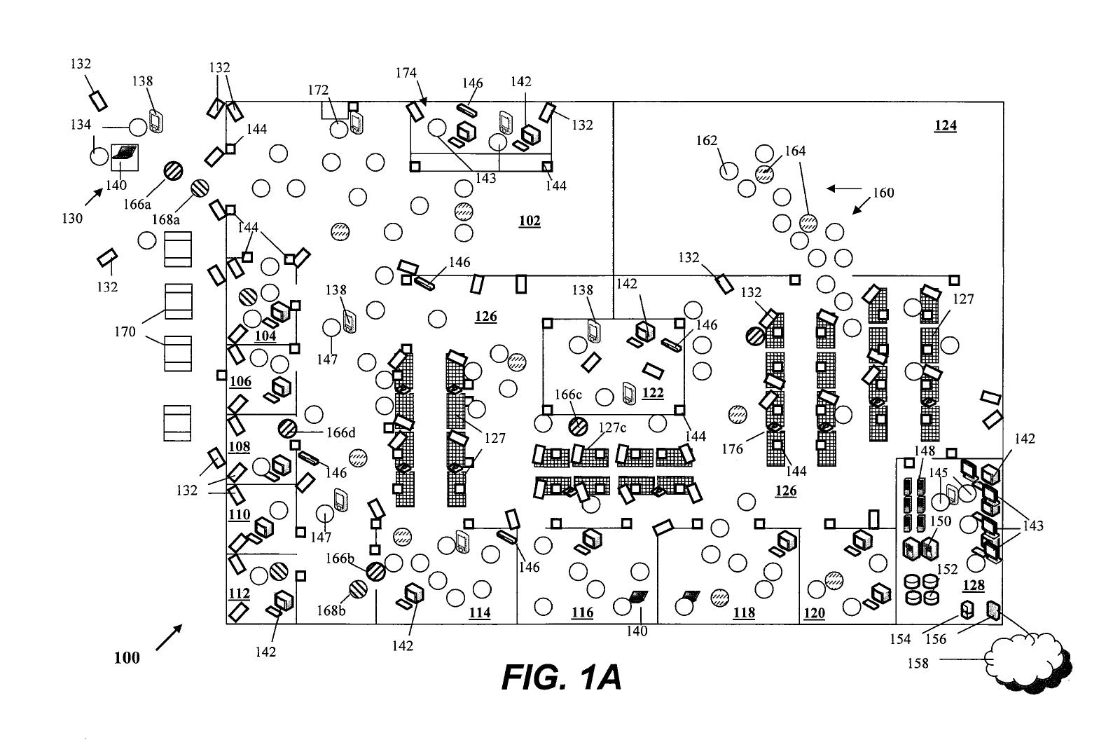

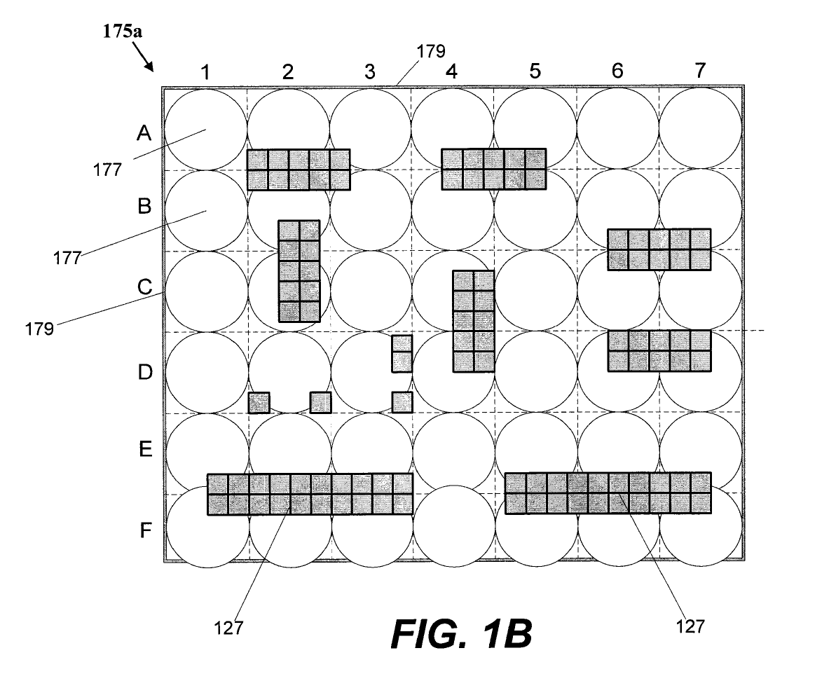

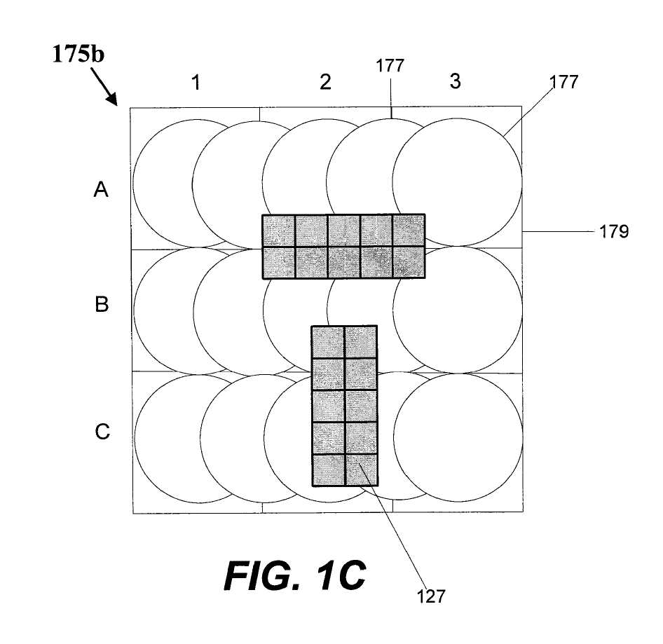

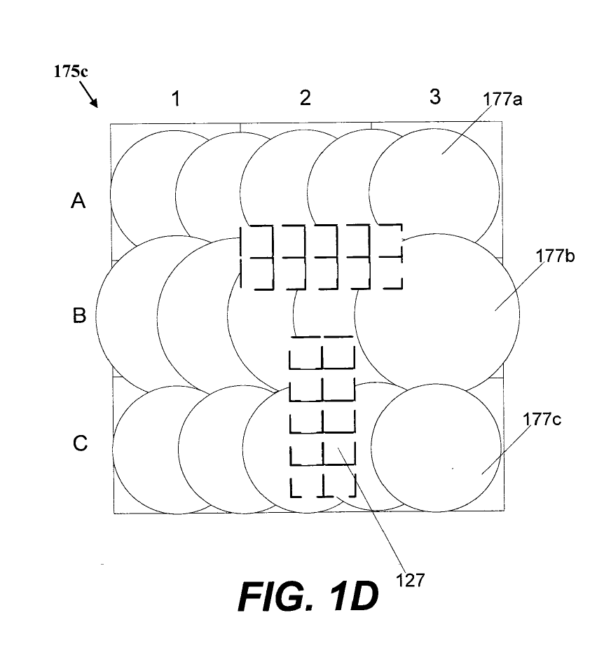

FIG. 1A depicts a simplified example of a casino configured for implementing some aspects of the invention. It will be appreciated the layout, the numbers and types of cameras, gaming machines and other devices, shops, etc. indicated in FIG. 1A are purely for the sake of example and that other layouts, etc., are within the scope and spirit of the invention. Some alternative layouts will be described below with reference to FIGS. 1B through 1D.

In this example, gaming establishment 100 includes valet area 130, lobby 102 and nearby shops 104, 106, 108, 110 and 112. These shops may include a range of retail establishments, including but not limited to souvenir shops, jewelry stores, clothing stores and the like. Food and beverage establishments 114, 116, 118 and 120 may include restaurants, sushi bars, buffets, or any such dining and/or drinking establishment.

Bar 122 is an island in the midst of the main casino/gaming area 126 that includes various gaming machines 127. Preferably, at least some of gaming machines 127 are configured for communication with other devices, including but not limited to one or more of servers 148, in order to provide various features discussed elsewhere herein. Auditorium 124 includes a stage and seating (not shown) for live performances. At the moment indicated in FIG. 1A, a number of patrons 160 are exiting auditorium 124.

Operators 145 and various devices for providing services and managing gaming establishment 100 may be seen in control room 128. This area includes host devices 142 to facilitate the communication of operators 145 with various other devices, such as other host devices 142 (which may serve as cash registers, hotel registration terminals, etc.), PDAs 138, laptops 140, gaming machines 127, etc. Host devices 142 may comprise desktop computers, laptops, workstations, or other such devices. Operators 145 may also communicate with other people, including but not limited to casino personnel 147, via PDAs 138, telephones, etc.

In this example, casino security functions as well as functions specific to the present invention may all be performed (at least in part) by devices and/or people in control room 128. However, in alternative implementations, the security personnel and/or devices may be located in a separate location. Moreover, as described below (e.g., with reference to FIG. 9), some implementations involve communications between a gaming establishment and other locations, e.g., communications between a gaming establishment and a central system and/or communications between gaming establishments.

Accordingly, host devices 142 (and other devices, as needed) may be configured for communication with servers 148, computing devices 150, storage devices 152 and external network 158, via gateway 154 and firewall 156. Network 158 is the Internet in this example, but may be one or more public or private networks. According to some implementations of the invention, additional storage devices and related devices may be accessed via network 158, e.g., a storage area network (“SAN”) or other types of network storage.

Control room 128 includes a plurality of monitors 143 for, inter alia, receiving image data from cameras 132. Cameras 132 may include, for example, “smart cameras,” closed circuit television (“CCTV”) cameras, closed circuit digital photography (“CCDP”) cameras, range cameras and/or webcams. Accordingly, the image data displayed on monitors 143 may include still digital images, video feeds, freeze-frames, etc. Such image data may be used for various purposes, including not only security purposes known in the art but also some implementations of the present invention.

Servers 148 and/or computing devices 150 may be configured to perform various functions, including but not limited to real-time player tracking and/or player loyalty functions, patron identification functions (including but not limited to biometric functions such as facial recognition functions), patron location functions, licensing, gaming, accounting, security services, etc. These functions may include those known in the art and those specific to the present invention. At least some of servers 148 may be configured for communication with cameras 132 and other devices (such as host devices), in order to provide real-time player tracking functionality and other methods described herein.

Some such implementations involve computer vision, machine vision and/or facial recognition systems. For example, some implementations of the invention leverage the ability of smart cameras. A smart camera is an integrated machine vision system which, in addition to image capture circuitry, normally includes a processor configured to extract information from images without the need for an external processing unit. A smart camera generally includes an interface system for communication with other devices. Some smart cameras can identify physical characteristics of individuals, even in a crowd, and track identified individuals as they move through the crowd.

For example, Tyxz, Inc. announced on Dec. 19, 2006 that its DeepSea™ G2 Vision System was able to successfully track visitors to an exhibit at the Smithsonian's Cooper-Hewitt National Design Museum in New York City. The DeepSea™ G2 Vision System may be configured for communication with other devices (e.g., other cameras, devices in control room 128, etc.) via TCP/IP. Accordingly, such smart cameras could provide useful data for implementing some aspects of the present invention.

A facial recognition system is a computer-driven application for identifying a person from one or more digital images. This is generally accomplished by comparing selected facial features in the live image with stored facial recognition data. Facial recognition data (some of which may be referred to as a “faceprint” or the like) may be compared to other types of data for more reliable identification. Such data may include biometric data, such as fingerprint or eye iris recognition data obtained from biometric devices 176 or elsewhere. Some embodiments of the invention provide for biometric devices 176 to gather biometric data unobtrusively, e.g., by including a fingerprint and/or thumbprint reader in one or more control buttons of a gaming machine. According to some implementations of the invention, a tentative patron identification may be evaluated in view of other biometric data, player preference data (e.g., as previously compiled in a player loyalty and/or player tracking database), hotel data, retail data, restaurant/beverage data and/or other data that may be available from other parts of gaming establishment 100 or elsewhere.

Facial recognition algorithms include eigenface, fisherface, the Hidden Markov model, and the neuronal motivated Dynamic Link Matching. An emerging trend uses the visual details of the skin, as captured in standard digital or scanned images. However, two-dimensional face recognition algorithms have shown to be sensitive to changes in lighting, different facial expressions, make-up and head orientation.

Three-dimensional face recognition (3D face recognition) methods involve the three-dimensional geometry of the human face. Some details of recent 3D face recognition methods are described by A. M. Bronstein, M. M. Bronstein and R. Kimmel in “Three-Dimensional Face Recognition” (Intl. Journal of Computer Vision, Vol. 64/1, pp. 5-30, August 2005), which is hereby incorporated by reference. It has been shown that 3D face recognition methods can achieve significantly higher accuracy than their 2D counterparts, rivaling fingerprint recognition in accuracy. Some 3D face recognition techniques involve measuring geometry of relatively rigid features of the face. Other methods use a 3D model to improve accuracy of traditional 2D facial recognition techniques by transforming the head into a known view. Some 3D face recognition methods implement depth perception by projecting a grid onto the face and integrating video capture of the face into a high-resolution 3D model. 3D face recognition methods generally require the acquisition of 3D images, which may require a range camera. Accordingly, the data storage and computational requirements for 3D face recognition methods are likely to be greater than those for 2D methods.

Computing devices 150 may be desktop computers, workstations, blade servers, mainframe computers, supercomputers or other such devices. The type and number of computing devices 150 may be selected according to the speed and number of calculations and other processes that will be required of them. For example, one or more of computing devices 150 (or other devices) may be used for processing data from cameras 132 (such as calculations for facial recognition systems and/or patron tracking), for calculations involved in biometric data analysis and/or other patron identification processes, etc.

In some implementations, each of the camera units may be remotely configured, e.g., by one or more devices of control room 128. In some such implementations, all camera units of a similar type may share the same rules and parameters. However, this need not be the case. Particularly when the cameras are individually addressable, specific rules and parameters can be applied as necessary. For example, certain cameras may record data only at specific times or when specific thresholds were reached, such as when at least a threshold number of moving objects (e.g., three or more) are in view. Preferably, all camera units will use consistent time codes to insure that data obtained from different cameras can be meaningfully combined.

In some implementations, selective compression may be automatically applied to the images so that the data transmission requirements would be reduced. For example, the system may apply minimal compression to floor areas where players or other people appear (or are likely to appear) and higher levels of compression to static background areas of the image.

In the example illustrated in FIG. 1A, a plurality of radio frequency identification (“RFID”) readers 144 are disposed in various locations of gaming establishment 100. RFID readers 144 and related devices may be used, for example, to read and determine the location of a patron's RFID device. Such a device may be a dongle, a bracelet, a “smart card” (which may serve as a player loyalty and/or player tracking card) or another such device. RFID readers 144 and related devices may also be used to determine the location of a portable gaming device that includes an RFID tag, etc. Further examples of how RFID readers 144 and related devices may be used according to the present invention are described elsewhere herein.

Accordingly, some of network devices 146 may be switches, middleware servers and/or other intermediate network devices in communication with RFID readers 144 and at least one of servers 148 that may be configured to provide RFID functionality, such as patron identification and/or location functionality. Depending in part on the size of the gaming establishment(s) involved, the number of RFID readers, etc., it may be advantageous to deploy various RFID-related devices at various hierarchical levels of an RFID network, which may include devices outside of gaming establishment 100. Some such devices and networks are described in “The EPCglobal Architecture Framework: EPCglobal Final Version of 1 Jul. 2005,” which is hereby incorporated by reference. Some network devices 146 may comprise wireless access points for providing a communication link with wireless devices, including but not limited to PDAs 138.

Moreover, one or more of servers 148 (and/or other devices) may be configured to synthesize various types of patron data. For example, one of servers 148 may be configured to determine whether a “read” from an RFID player loyalty device corresponds with the location (and/or identification) of a particular patron whose activities correspond with a defined event of interest to the casino. The server may use the indicated location to synchronize patron tracking data from a smart camera, e.g., by plotting the indicated location on the same display used for a smart camera's patron tracking display.

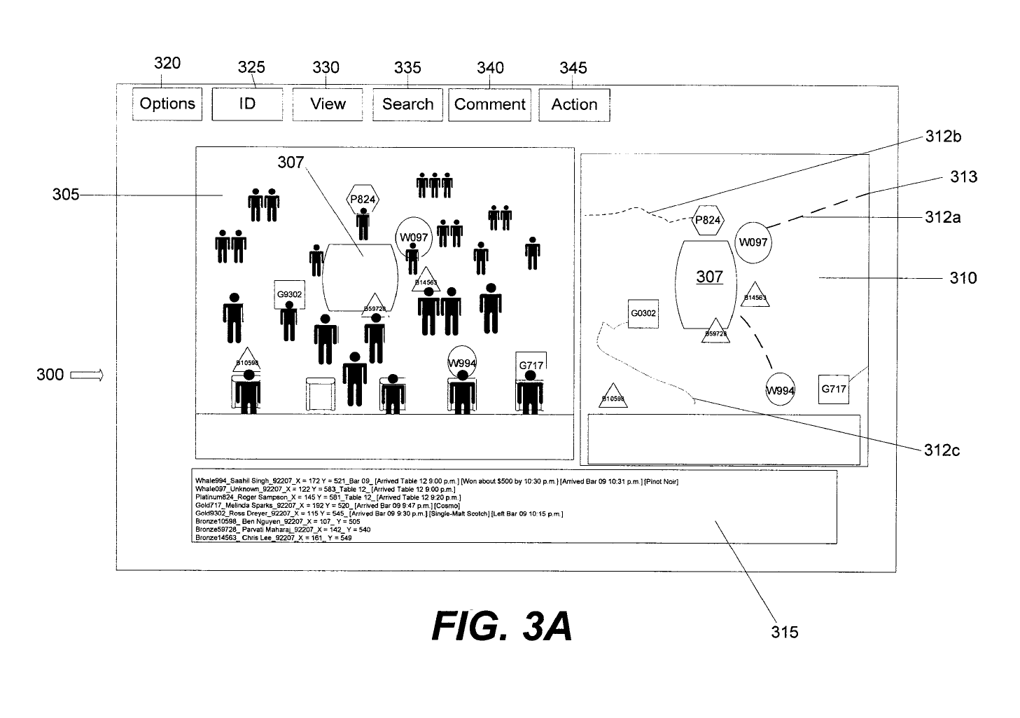

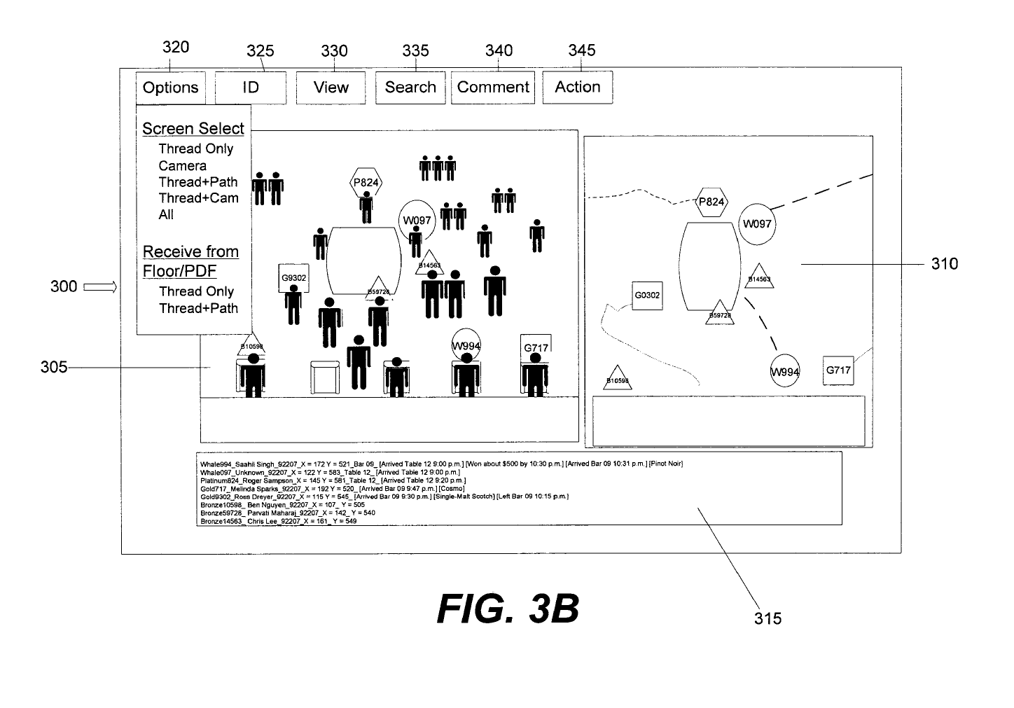

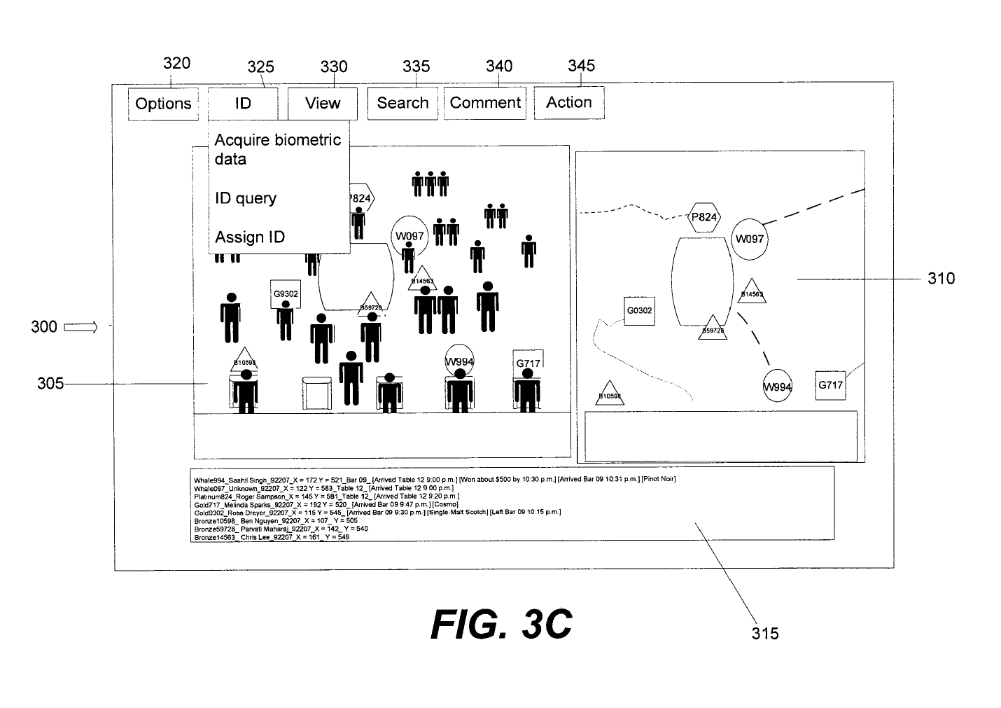

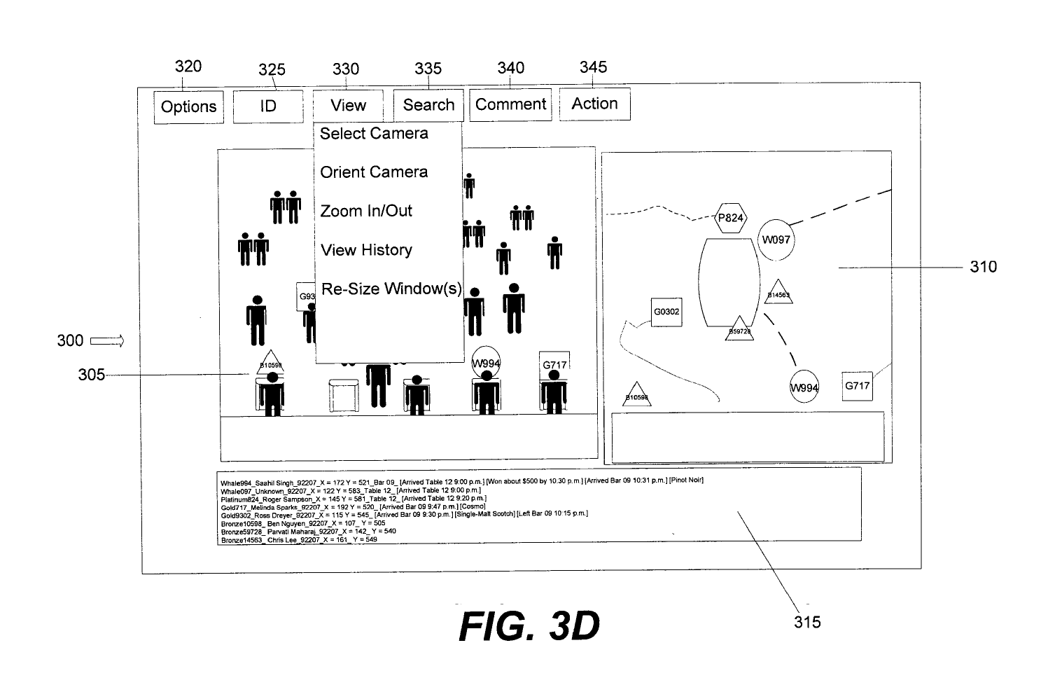

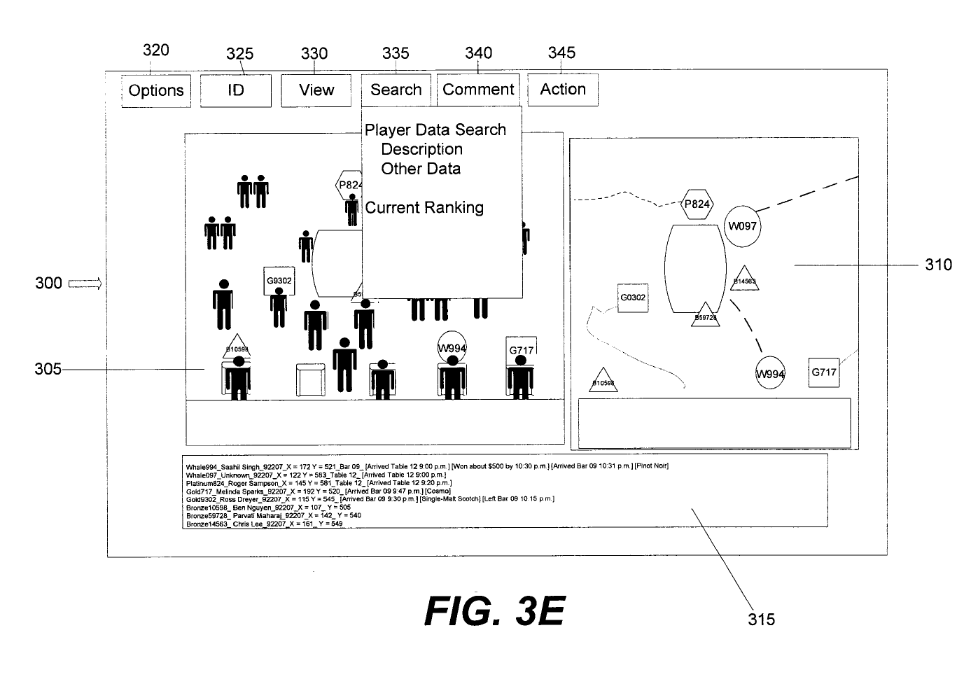

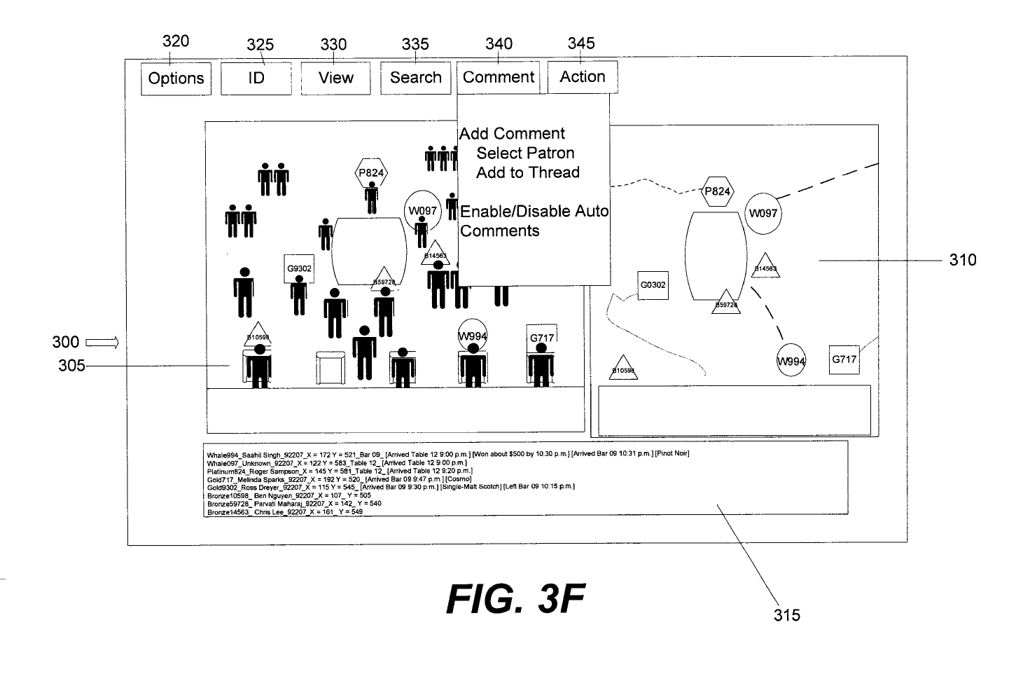

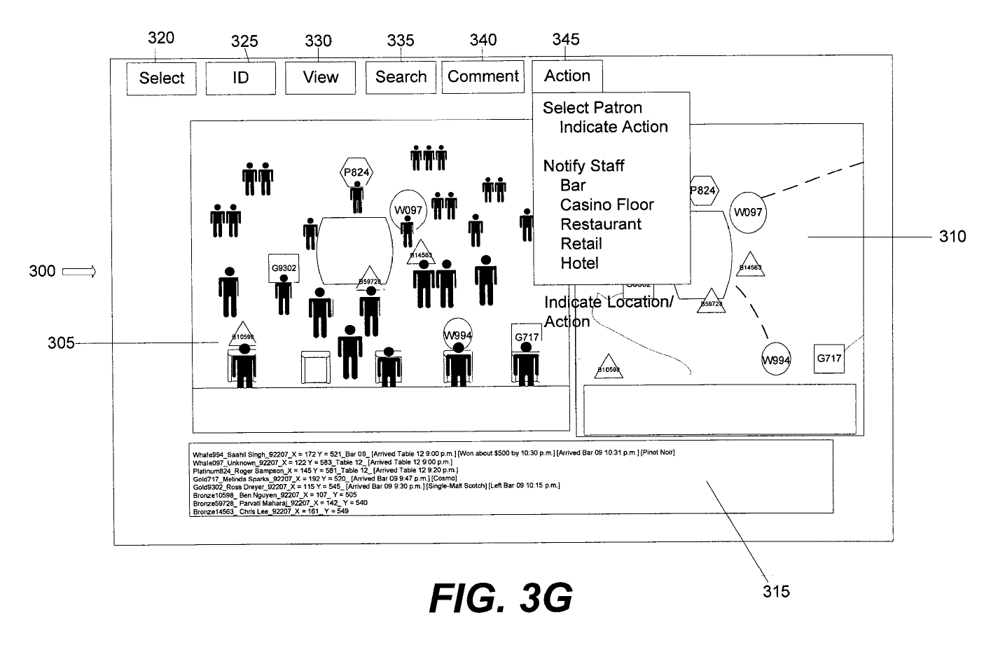

Other casinos may or may not have RFID readers and/or an associated RFID network. However, most aspects of the present invention can be implemented regardless of whether a casino has these features. For example, a device (e.g., a server) may synchronize camera data and location data in other ways, e.g., by making a correspondence between a known location and an image of the location, e.g., making a correspondence between a known location of a gaming machine and an image of the gaming machine. An operator (or a device, such as a smart camera) could make a correspondence between a patron of interest and an area of a map grid, e.g., a grid displayed on a display screen and superimposed on an image of the casino floor (e.g., an overhead view). In one such example, an operator could indicate a patron of interest by touching an area of a touch screen corresponding to the patron and the location. Some such displays will be described below, e.g., with reference to FIGS. 3A through 3G.

Some implementations of the invention provide a mesh of networked camera units that provides a video-based infrastructure for tracking people and activities of interest. Some such implementations involve player tracking (and related activities) in casinos.

However, the invention is not limited to casino-related implementations. Instead, some video-based infrastructures of the invention (and related methods) have wide applicability to other contexts. For example, many other types of businesses could benefit from identifying valued customers or potential customers, collecting data regarding these individuals and/or providing enhanced services to them. Such businesses may include retail establishments such as department stores, motor vehicle dealerships, power and sailboat dealerships, jewelers, watch dealers, etc. (particularly for those establishments that provide high-end merchandise), as well as high-end night clubs, restaurants and the like. Moreover, some such implementations of the invention could provide value in the security context, e.g., by providing infrastructure for identifying individuals and actions of concern, tracking them, etc.

Some examples of networked camera unit meshes will now be described with reference to FIGS. 1B through 1D. FIG. 1B provides a top view of system 175a, which includes a plurality of networked cameras in a portion of a casino This view may be, for example, presented on a display of one or more devices indicated in FIG. 1A (e.g., one of host devices 143). Here, the smaller squares with darker outlines represent a number of gaming machines 127, which are depicted in various configurations.

System 175a preferably includes as many independent camera units as necessary to cover the desired area. Here, each camera has an associated field of view 177. The camera units may include a video camera, one or more logic devices (e.g., processors), local data storage and network communications capabilities. However, the configuration and distribution of the camera units may vary depending on the implementation. For example, FIGS. 1B through 1D indicate camera units having a particular orientation, whereas a number of camera orientations may be preferable.

In addition to cameras and gaming machines, system 175a includes the necessary network devices, host devices, one or more servers, etc., such as those described above with reference to FIG. 1A and/or those described below with reference to FIG. 9. Such devices may be configured, inter alia, to coordinate the activities of the camera units and to perform other methods described herein. However, neither the cameras themselves nor these other details are depicted in FIG. 1B, in order to focus attention on the interplay between camera fields of view and corresponding areas of the casino.

In this simple example, the indicated portion of a casino has been divided into a plurality of cells 179 of approximately equal size. The cells 179 may or may not be presented on a display device. It will be apparent to those of skill in the art that the casino itself will not necessarily include physical manifestations of the cells 179.

Here, each of the cells 179 is further identified according to its position in system 175a. In this example, each row has been assigned a corresponding letter and each column has been assigned a corresponding number. In this way, each of cells 179 can be uniquely identified according to a combination of a letter and a number: for example, the cells 179 having labeled fields of view 177 may also be referred to as cells A1 and B1. However, any convenient manner of identifying areas of the casino may be used. Moreover, it is convenient, but not essential, that the cells are the same size.

In this example, each of the fields of view 177 is approximately coextensive with a corresponding cell 179 of system 175a. Whereas FIG. 1B indicates that the camera field of view areas 177 are merely touching at their perimeters, this representation has been made primarily for ease of illustration. In some preferred implementations, the camera field of view areas 177 overlap to prevent blind spots. Some such overlapping implementations are described below with reference to FIGS. 1C and 1D.

In some implementations, each camera has its own identification (“ID”) code, which may be a numerical code, an alphanumeric code, or the like. For the layout depicted in FIG. 1B, for example, the cameras can be identified according to the row and column of the corresponding cell, e.g., as cameras A 1 though F7. Therefore, in this example each camera ID corresponds to one of cells 179, which in turn represents an area of the physical floor layout. Other elements of the casino may also be assigned ID codes. Here, each gaming machine is also assigned an unique ID, though the ID is not shown in FIG. 1B.

As described in detail below, casino patrons may also be assigned an ID, which may or may not correspond with a player loyalty account number. Using such an identification process it is possible to positively locate any person or object of interest on the casino floor.

FIG. 1C illustrates an example of a system 175b of networked camera units that have overlapping fields of view 177. In this example, the fields of view 177 are approximately the same size, but overlap along each row. In either case, the labels of cells 179 may be used to identify uniquely each camera. For example, the top row of cameras could be identified as A1, A1.5, A2, A2.5 and A3.

Similar overlaps may be made along each column. In some such examples, the fields of view 177 are approximately the same size. However, as shown in system 175c FIG. 1D, fields of view 177 do not need to be approximately the same size. Here, the fields of view 177a of row A are approximately the same size as the fields of view 177c of row C. However, the fields of view 177b of row B are larger than fields of view 177a or fields of view 177c. This configuration allows the fields of view 177b to overlap not only with fields of view 177b in the same row, but also with fields of view 177a and 177c in adjacent rows.

Even though the fields of view 177b extend beyond the corresponding cells in row B, the cameras could still be identified in a manner such as that described above. Here, for example, the cameras in row B could be identified according to the location of the center of each field of view 177b, as cameras B1, B1.5, B2, B2.5 and B3.

Accordingly, a grid cell arrangement of camera locations provides various advantages. Some of these advantages will be discussed in further detail below. However, a variety of other methods may be used to associate cameras with areas of a casino. For example, camera locations could correspond with gaming machine locations, bar locations, retail locations and other locations in or near the casino. Therefore (and as noted in FIG. 1A), the camera locations do not necessarily correspond to a grid having uniform grid cells.

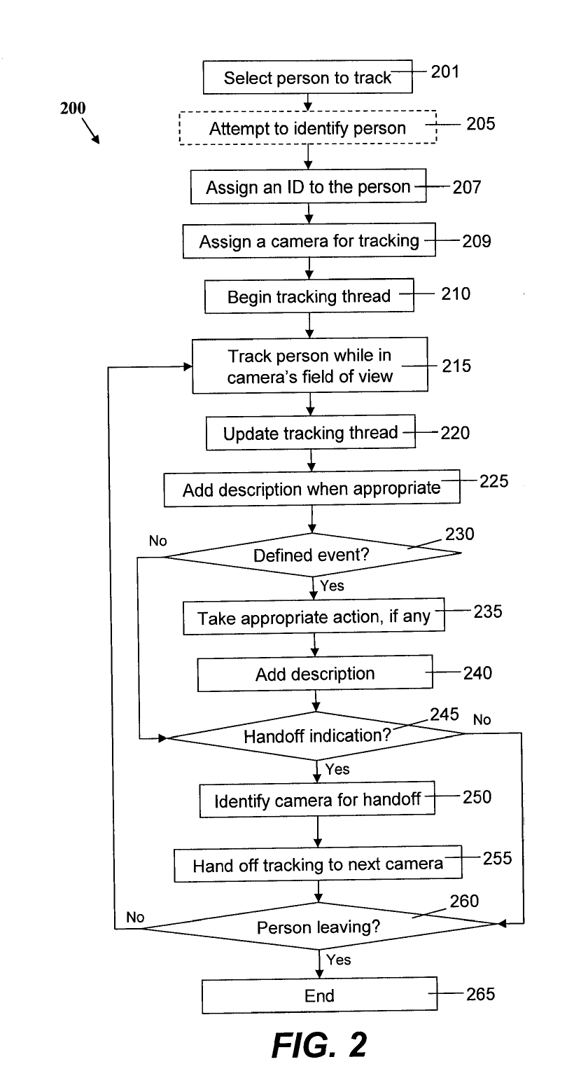

Some casino-oriented implementations of the invention will now be described with reference to FIG. 2. It will be appreciated that the steps of method 200 (as with other methods shown and described herein) are not necessarily performed in the order indicated. It should also be understood that the methods of the invention may include more or fewer steps than are indicated.

Although in theory all casino patrons could be tracked in real time, this could prove to be very challenging in practice. A large number of personnel, “smart cameras” related devices would be required for tracking all casino patrons in such a fashion. Moreover, a substantial amount of data would need to be acquired and stored for patrons that may have little or no economic value to the casino.

Many casinos may prefer to reduce the associated costs by implementing a more selective real-time patron tracking program, in which only selected patrons are tracked in real time. Therefore, in some implementations little or no real-time tracking is performed for patrons for whom there has not been an indication of economic value to the casino. If a defined event is received regarding such a patron, that patron may be re-categorized and tracked in real time (or a higher level of real-time tracking could be performed). Instead of storing and/or analyzing hours of audiovisual data for such patrons, in some implementations a text string may be used to summarize low-level patrons' activities, e.g., “This person sat in [location] for 3 hours and spent $X.” Such implementations require a lower level of casino resources and save storage space.

Accordingly, some preferred implementations of the invention involve selecting a patron to track. (Step 201). This selection may be made in a variety of manners. In some preferred implementations, step 201 may involve the determination of defined events and/or “high-roller” indicia.

For example, if a patron has attained a high level in the gaming establishment's player loyalty program (e.g., is a “platinum level” player), that player may be selected in step 201. The player may be identified by a casino employee or may be identified when a player loyalty instrument is detected, e.g., when the player inserts a player tracking card into a gaming machine. Either instance may be considered one example of a defined event. In such instances, the player's identity may be known before the player is selected; as such, step 205 may be performed prior to step 201.

In some instances, even if a patron's identity is unknown, there may nonetheless be indications that the patron may be relatively more likely than other patrons to spend a significant amount of money while visiting the gaming establishment. Such a patron may be referred to herein as a “potential high roller” or the like. Similarly, evidence that a patron is a potential high roller may be referred to as “high roller” indicia or the like.

Such evidence may be detected even before the patron enters a casino. For example, the patron may arrive in a particularly expensive automobile 170. (See FIG. 1A.) The patron (or the patron's companion(s)) may be wearing an expensive watch, expensive clothing and/or expensive jewelry. Relevant observations may be made by a human being and/or by one or more devices according to images received by one or more of cameras 132. Accordingly, step 201 be performed, at least in part, by one or more valet attendants 134, operators 145 and/or by devices used by such persons.

For example, a casino employee may notice (e.g., when a patron pushes up the cuff of his shirt or jacket) that a patron is wearing an expensive, rare or custom-made watch, e.g., a Rolex™, a Patek Philippe™, a Jaquet DroZ™, a Tiret Splash™, etc. The employee could send a signal to a device and/or to one of operators 145 in the control room 128 (for example, by using a PDA or the like) indicating the detection of a defined event and identifying the patron in some manner, e.g., according to his location. Image data may be acquired from one or more of cameras 132 and used as input data for the determination of step 220, whether by a device executing a pattern recognition program or by a person, e.g., one of operators 145.

However, in some implementations of the invention, step 201 (and possibly other steps of method 200) may involve automated processes. For example, one or more devices (e.g., servers 148 of control room 128) may be configured to recognize certain patterns associated with high rollers, such as the logo, shape, etc., of a particular automobile in an image captured by one of cameras 132. Such a device may be configured, for example, to recognize a Mercedes Benz, BMW or Porsche and to identify the driver (and possibly passenger(s)) as high rollers. Similarly, such a device may be configured to recognize a Maserati, Ferrari or Lamborghini and to identify associated patrons as a higher category of high rollers. The device(s) involved in such automated processes may or may not be the same device(s) involved in determining “defined events,” as described below with reference to step 230.

Alternatively, or additionally, the determination of step 201 may involve other automated processes. For example, one or more of RFID readers 144 may read an RFID tag associated with a player, e.g., an RFID tag disposed on a player loyalty card, dongle or other device. In one such example, one or more of RFID readers 144 near the entrance of gaming establishment 100 may read an RFID tag disposed on a player loyalty card and may provide this information to a player loyalty server in control room 128. The player loyalty server may determine that a patron has attained a high level in the gaming establishment's player loyalty program, e.g., is a “platinum level” player. In some instances, this determination may be made long before the patron seeks to use the player loyalty device at a gaming machine.

As described in more detail below, some implementations of the invention involve a process of ranking current patrons of a casino. This may be desirable for a variety of reasons, such as the need to vary the number of patrons tracked in real time according to the available casino resources, varying numbers of patrons at different times, a desire to ensure that certain types of patrons (e.g., high-level player loyalty program members) are tracked, etc. Accordingly, step 201 may involve some type of ranking process such as one of those described below.

If a patron selected for real-time tracking has not yet been identified, an attempt is preferably made to identify the patron. (Step 205.) Step 205 may involve human input and/or automated processes. For example, step 205 may involve determining whether the patron can be recognized by one or more of valet attendants 134, operators 145, bell staff 172 and/or hotel desk staff 174. If the player is using a player loyalty instrument while playing a gaming machine, a player may be identified according to a player loyalty account. If not, biometric data, such as facial recognition data, fingerprint data and/or retinal scan data may be used to identify a patron.

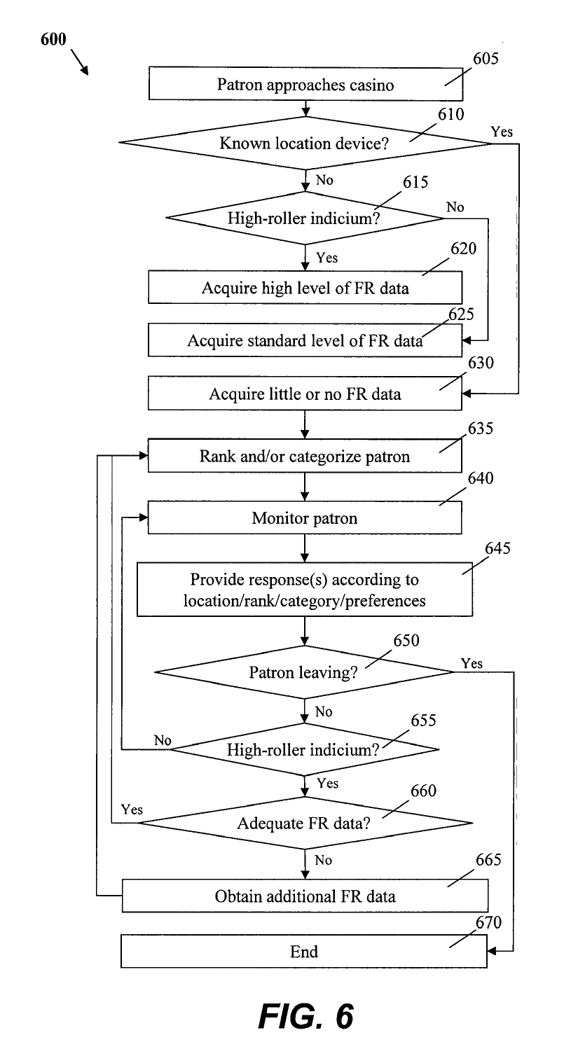

Some implementations involve expending different levels of resources for attempting to identify patrons having different levels of high-roller indicia and/or different levels of defined events. Some examples are described below with reference to FIG. 6. In alternative implementations, an identification attempt may be made and/or some level of real-time player tracking may be performed regardless of whether high roller indicia or a defined event is determined in step 201. However, even in such implementations, relatively more resources may be devoted to attempts to identify a patron that appears to be of more economic value to a gaming establishment, e.g., as indicated by high roller indicia and/or a defined event.

If the patron can be identified (at least preliminarily), more information may be determined about the patron, e.g., according to public or private databases. Some such data may be associated with the patron, if so desired.

Whether or not a patron is positively identified in step 205, an identification code of some type is preferably associated with the patron. (Step 207.) If a patron is a member of the casino's player loyalty program and is the patron's player loyalty instrument has been detected (e.g., if the patron has inserted a player loyalty card in a gaming machine), the identification code may be the player loyalty account code or a variation of the player loyalty account code. If no known identification code is associated with the patron, a code may be assigned in step 207.

An ID code may be associated with other patron identification data such as image data, facial recognition data, voice data and/or other biometric data. The ID code may include classification information, e.g., indications of a patron's category (e.g., “high roller,” “whale,” “platinum,” etc.) and/or rank. In RFID-enabled implementations, if a patron has an RFID tag that cannot be identified, the tag read data may be used as the ID code or associated with another ID code that is assigned by gaming establishment 100. Any such RFID tag may be used to identify and locate a patron within a network of RFID readers 144, including but not limited to an RFID tag for an article worn or carried by the patron.

In this way, even if a patron is not a member of the gaming establishment's player loyalty/player tracking program and/or cannot be initially be identified by name, data regarding the patron may nonetheless be gathered and associated with that patron. Some patrons may prefer not to be identified by name and may seek some degree of anonymity. Accordingly, the present invention allows players to remain un-identified by name, yet still allows a gaming establishment to identify patrons of interest, gather data regarding them and differentiate the treatment of patrons accordingly.

In step 209, one or more cameras are assigned for tracking the patron. In this example, a single camera is assigned. Multiple-camera implementations will be described below. A camera assignment may be made by associating an area of a casino floor with a particular camera. In some implementations, a live video capture from a camera may be superimposes over a static background display, e.g., a display such as that indicated above with reference to FIGS. 1B, 1C and/or 1D. For example, if a patron were observed in cell B2 of FIG. 1B, a camera corresponding to cell B2 may be assigned to track the patron. The observation and camera assignment may be made by a human or automatically: using pattern recognition allows moving objects (such as people) to be distinguished from the background. If numerous patrons are in the same area, an operator may select the appropriate one for tracking, e.g., by touching a screen on which the patrons are displayed.

The camera unit associates the patron ID with the observed patron and starts a tracking thread. (Step 210.) This thread may contain, e.g., a patron ID, time stamps along the track and the camera ID, as well as positions and/or activities of the patron at different times. Such annotation allows for easy access to digitally stored video image data associated with the tracking thread. Some examples are described below, e.g., with reference to FIGS. 3A through 3G.

The patron is tracked while in the camera's field of view. (Step 215.) As the patron moves through the camera's field of view, the tracking thread is updated. (Step 220.) The patron's movement and/or activities may be noted in the thread, e.g., in the form of description associated with a time stamp and/or with audiovisual data. (Step 225.) The system may continue to track identified patrons even when they are temporarily not moving, e.g., when a player sits and plays a slot machine.

However, some preferred implementations of the invention are event-driven, such that information is generated when triggered by an event (e.g., a wager of a particular size, a purchase of at least a threshold amount, etc.). The underlying idea is that the casino probably does not need to be recording everything constantly. Instead, when a defined event of interest takes place (as determined in step 230), a person and/or a device will make a record of the event. (Step 240.)

The terms “patron data,” “patron event data” and the like are used broadly herein to include the actions taken by patrons as well as other data regarding patrons. Some such data may lead to the identification of a known or potential high-value patron and other such data may not. As such, high roller indicia and defined event data may be subsets of patron data.

Accordingly, patron event data are preferably monitored to determine whether a defined event has occurred. This monitoring preferably involves other patrons in addition to those patrons being monitored in real time. Such patron event data may include, for example, data from a gaming machine, a gaming table, etc. Some defined events may be simply wagers, credits and/or a “coin in” of at least threshold amounts. For example, a casino could define one defined event to be a credit of at least $100 in a gaming machine, the purchase of at least $200 worth of poker chips, a wager of at least $10 on hand of blackjack, etc.

Other examples of defined events may be purchases, tips, or other spending in or around a gaming establishment. These expenditures may or may not be directly related to wager gaming. For example, a defined event may involve a retail purchase of a least a predetermined amount, e.g. of at least $500. A defined event may involve a valet tip of at least $10. A defined event may involve how much a patron spends on food or beverages at a particular meal, within a predetermined time (e.g., at a bar and/or while wager gaming), etc. For example, a defined event may be determined if a patron orders a bottle of wine that costs at least $100, spends more than $200 per person at dinner, spends at least $100/hr. on drinks over a predetermined period of time, etc. Accordingly, a defined event may involve a single expenditure and/or a rate of spending over time.

It will be appreciated that defined events may involve patron events at a plurality of locations in various circumstances, involving a range of possible devices and interactions with various individuals. The person and/or device involved with detecting and reporting the defined event may vary according to the type of event and the devices and networks implemented by the casino. At some casinos, for example, at least some table games may involve automated chip detection systems, such as RFID-enabled systems, whereas other casinos may not have such automated systems. In the latter case, a person may need to determine whether a patron's wagering level, chip purchase level, etc., at a table game has reached a “defined event” threshold, whereas in the former case an automated chip detector (e.g., an RFID reader) could provide a signal when such a threshold is reached. Moreover, table games, cash registers in retail shops, etc., may or may not be included in a player loyalty system.

Accordingly, the determination of step 230 may be based upon information determined via multiple sources, which may include various people, devices and/or networks. Examples of such networks include casino-related networks (e.g., wager gaming networks, player loyalty and/or player tracking networks, hotel management networks, retail networks, restaurant, beverage networks and/or entertainment networks) as well as external networks.

However, if a typical patron is merely, e.g., having a typical session at a gaming machine, most of the player's activity may not need to be recorded as audiovisual data or descriptive data. This is true in part because much relevant data may be captured automatically by the gaming machine and/or an associated player loyalty system. Such implementations can greatly reduce the demands on casino resources. For example, such implementations can reduce the amount of data that is stored for adding descriptions to audiovisual files. A corollary benefit is that such implementations can allow specific events and descriptions to be located more easily.

As will be described in more detail below, the detection of a defined event in step 230 may cause one of various rule sets to be applied by a person and/or a device. (Step 235.) Such a rule set may involve the collection of additional patron data and associating the acquired patron data with the corresponding patron. The additional patron data may be acquired at a future time and/or may be determined by analyzing previously-acquired data, such as previously-acquired image data. (Some examples are described below with reference to FIG. 3D; further examples are provided in the “Real Time Player Tracking” application, which has been incorporated by reference.) Moreover, the rule set may involve providing services or other benefits to a patron.

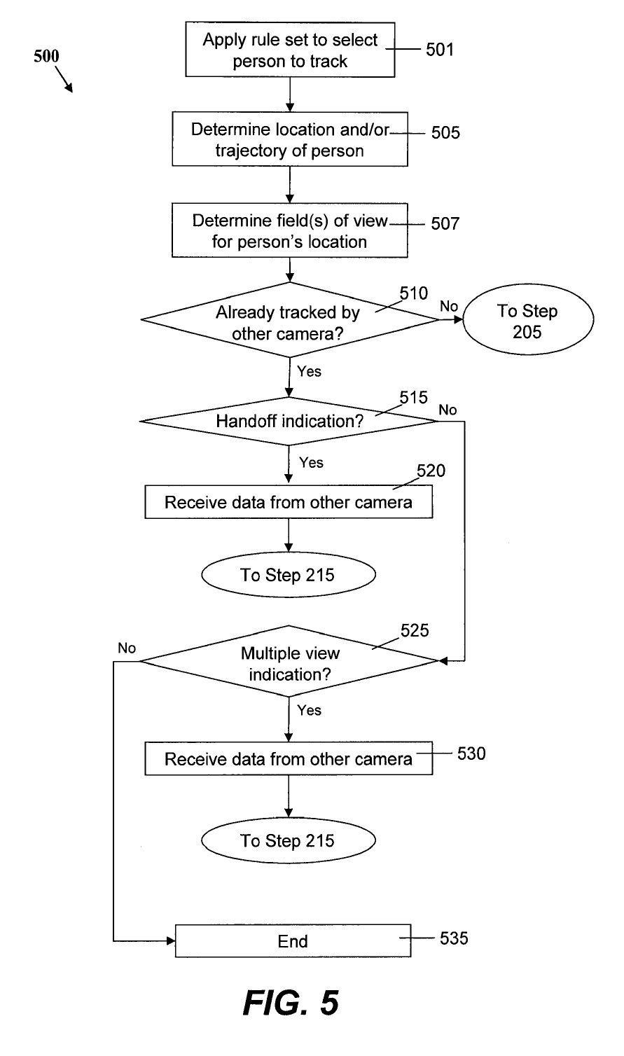

When there is an indication to “hand off” the real-time tracking of a patron to another camera (as determined in step 245), the appropriate camera for continuing the patron's real-time tracking will be identified. (Step 250.) The next camera may be identified by a smart camera, a server, an operator, etc. For example, referring to FIG. 1B, if a patron were to move from grid cell D4 to grid cell E5, the camera associated with grid cell D4 would hand off responsibility for tracking the patron to the camera associated with grid cell E5. (Step 255.) Data regarding the patron, including but not limited to tracking thread information, may be relayed to the camera associated with grid cell E5. The patron's location data, velocity data and/or trajectory data may be handed off and/or used as a basis for determining whether to transfer the operations to another camera. Details of such determinations hand-offs are discussed in more detail below, e.g., with reference to FIG. 5.

The patron may be tracked in real time until the patron leaves the casino. In alternative implementations, a patron may be tracked only so long as the patron maintains a sufficiently high rank relative to other patrons currently in the casino, as described below.

When a patron leaves the casino (as determined in step 260), the process ends. Real-time tracking data, including description data, may be saved. If the patron is a member of the casino's player loyalty program, such data may be associated with the patron's player loyalty account. Audiovisual data may also be saved, at least for higher-ranked patrons. In some implementations, audiovisual data may be retained only for a predetermined period of time, because of the relatively large amount of memory required to store such data.

Some implementations of the invention provide features, such as software, graphical user interfaces (“GUIs”), etc., to facilitate real-time player tracking and/or related activities, including but not limited to the activities indicated in FIG. 2. In some such implementations, tracked patrons may be identified according to an ID code, a color and/or a geometric shape which may be displayed on a display device. In some such implementations, the color and/or shape may signify a patron's rank, classification, etc. Other people, such as security personnel, maintenance personnel, people who have been identified as potential security risks, etc., may also be assigned a characteristic color and/or shape. Alternatively, or additionally, the movement of patrons may be displayed as a line or curve on a map view.

Some examples of software and GUIs for real-time tracking, adding description, etc., will now be described with reference to FIG. 3A. The specific examples of display layouts, shapes, colors and other such details are merely made by way of example; the present invention encompasses not only the particular examples described below but many other such embodiments.

Display 300 includes area 305 for displaying a real-time video feed from a selected camera. In this example, a characteristic geometric shape is associated with players selected for real-time tracking. The patron's ID code is displayed in the geometric shape in this example. In this example, patrons that are not currently being tracked in real time have no associated geometric shape.

Here, a triangular shape is associated with the lowest level of tracked patrons. For example, a bronze-level member of the casino's player loyalty program having player ID code B10598 is seated in the foreground. A triangle indicating player ID code B10598 is associated with this patron.

In this example, a polygon having more sides is associated with higher-ranked players. For example, a gold-level member of the casino's player loyalty program having player ID code G717 is also seated in the foreground. A square indicating player ID code G717 is associated with this patron. Similarly, a hexagon is associated with platinum-level patron P825, who is currently standing next to a gaming table.

Here, circles are associated with the highest-ranked players that are being tracked in real time. For example, an unknown high-roller or “whale” (who is also currently standing next to the gaming table) has an associated circle and the player ID code W097.

Other people may be assigned other characteristic shapes. For example, a badge icon may be associated with security personnel. A tool such as a screwdriver or a wrench may be associated with maintenance staff. A skull and crossbones may be associated with people who have been identified as potential security risks.

Moreover, in some implementations, some or all of the patrons and/or their corresponding shapes may also be displayed with an associated color. For example, all whales may be displayed in blue, security staff in red, novices/new members in green, etc. Alternatively, lower-level patrons may be relatively cooler colors and higher-level patrons may be relatively hotter colors. In one such example, representations of the lowest-level of patrons that are tracked (here, the triangles) could be purple, representations of mid-level patrons (here, the squares and other polygons) could range from blue through orange and representations of the highest-level patrons (here, the circles) could be red.

Such characteristic shapes, color schemes, etc., make the data easier for human beings to sort. Therefore, such displays facilitate providing an appropriate level of real-time player tracking, appropriate responses, etc. For example, a pit boss in a high-limit area may care only about the whales, where they are, what they are doing, etc. If, for example, a security guard is attempting to remove a person identified as a security risk, having characteristic colors and/or patterns for each person reduces the chance of interference by another casino employee who may seek to “rescue” the person identified as a security risk from the security guard. Moreover, when a patron moves from one camera's field of view to another, patrons of interest may already be identified, associated with a predetermined color and/or pattern and with a pre-existing tracking thread.

In area 310, the symbols representing the current locations of tracked players are displayed. Moreover, paths 312, indicating the recent prior locations of tracked players, are also displayed. Here, paths 312a of the “whales” or highest-level tracked patrons are made to be the most prominent, being long dashes of the heaviest line weight. Paths 312b of platinum-level patrons are moderate dashes of medium line weight, whereas paths 312c of gold-level patrons are dotted lines of the lightest line weight. In this example, prior locations of the lowest-level players are not displayed in area 310, but in other implementations the prior locations of all tracked players may be displayed.

In some implementations, at least some points of the paths 312 are saved in a format that allows a patron's movement to be tracked before and after the patron enters the field of view indicated in area 310. For example, points of paths 312 may be saved according to a coordinate system (e.g., an x,y grid, an x,y,z grid, or any other convenient system of coordinates) that extends beyond an individual camera's field of view, e.g., that extends throughout the casino. Relatively more points may be saved if the path 312 has relatively more inflection points or is otherwise relatively more complex.

Using a coordinate system that extends across multiple camera fields of view allows patron location data to be “stitched” together to form an extended path 312. Such extended paths provide a history of a patron's movements while in a casino. When whale 097 entered that portion of the casino that is displayed in area 310, for example, path 312a could be linked with the previous locations (and other patron data, such as video data) of whale 097 that are outside of area 310 and beyond point 313. Some implementations allow the extended path 312a to be displayed, as discussed below with reference to FIG. 3D.

Tracking threads of tracked patrons are displayed in area 315. The information presented, format, etc., are merely by way of example; many other permutations are within the scope of the invention. Here, the threads are displayed in a format that is easy for a person to read and that includes only recent events. Date and time stamps, for example, are displayed along with descriptions of noteworthy events. Other implementations may provide more or less information in a patron's thread (e.g., may include data regarding earlier times, prior gaming sessions or casino visits), may display more or less information in an area of the display, may display threads only upon request, etc.

In this example, relatively more casino resources are allocated towards real-time tracking of higher-ranked patrons. Therefore, the displayed threads indicate relatively more information for higher-ranked patrons. For example, the top thread pertains to “whale” W994, whose name is Saahil Singh. The thread indicates the current date (Sep. 22, 2007) and Mr. Singh's current location (X=172, Y=521), which happens to be the location of a seat at the bar in the foreground. The bar is referenced in the thread as Bar No. 9. Several descriptive data entries has been associated with Mr. Singh. We can see that Mr. Singh arrived at gaming table 307 (referred to as “Table 12” in the tracking thread) at approximately 9:00 p.m. and that Mr. Singh won about $500 by 10:30 p.m., then proceeded to Bar No. 9 about one minute later and ordered a glass of Pinot Noir. Mr. Singh's path 312 from the gaming table to the bar may be seen in area 310 of the display.

Another whale has been observed in the vicinity and is also being tracked in real time. The identity of whale 097 is unknown. However, description has been added to this unidentified whale's thread: it was observed that whale 097 arrived at the gaming table at approximately 9:00 p.m.

In this example, descriptions may also be added for gold-level members of the player loyalty program, even if there is no significant defined event has been detected. Here, gold-level member G9302, named Ross Dreyer, is currently standing near the gaming table. (X=115, Y=545) We can see that Mr. Dreyer arrived at the bar at around 9:30 p.m., had some type of single-malt Scotch and then left the bar at 10:15 p.m. Mr. Dreyer's path 312c is indicated in area 310.

However, in this example, there is relatively little information indicated regarding bronze-level patron number 59728, Parvati Maharaj, who is currently standing near gaming table 307: only the date (Sep. 22, 2007) and the patron's location (X=142, Y=540) are displayed in her thread. Similarly, the paths of relatively lower-level players are not tracked or displayed in this example. This situation could change if a defined event were detected regarding this patron (as determined in step 230 of FIG. 2), e.g., if she were observed to be wagering above a threshold level, made a large retail purchase, booked a luxury suite in the casino hotel, etc.

In this implementation, a user may interact with GUI 300 to perform various functions. FIG. 3B indicates some possible options that a user may select using “Options” menu 320. As with the other menu options depicted, some or all of these options may have sub-menus or may, if selected, invoke other menus and/or windows. Here, the “Screen Select” option allows the user to select various screen display options. For example, a user may select to have only area 305 displayed on the screen, only area 315 displayed on the screen, combinations of these areas displayed, etc. In some instances, e.g., when making descriptions, it may be advantageous to have area 315 enlarged to take up more of the screen. At other times, area 315 may be distracting or a user may simply want to have relatively more of other areas displayed.

In this example, a user may choose what types of information to receive from devices used by casino staff, e.g., PDFs used by staff on the casino floor. In some instances, an operator may desire to receive only descriptions that may be added to a thread, e.g., of defined events that have been detected and transmitted via a PDF. In other instances, an operator may desire to receive additional data, such as location or “path” data. This may be advantageous, for example, if a user wishes to check the patron's location and determine that the correct patron is being referenced.

FIG. 3C indicates some identification functions that a user may select from “ID” menu 325. Here, a user may choose to obtain biometric data from a selected patron. For example, the user may first select a patron displayed in area 305, e.g., by touching the patron's image on the screen, by using a mouse and “clicking” on the patron's image, etc. The “Acquire biometric data” option may, for example, invoke whatever biometric data system is available and appropriate for the occasion. For example, selecting this feature may cause one or more digital cameras to “zoom in” on the patron and take high-resolution digital images, then transmit the images to a device that can execute facial recognition software. If the patron is playing a gaming machine, a fingerprint sensor on the gaming machine, e.g., on a “Play” button or the like, may be activated. These data may be relayed to a device configured to execute fingerprint identification software.

An “ID query” may be a more general request for patron identification. For example, staff working nearby on the casino floor, at the casino's hotel desk, hotel security, etc., may be notified that the patron's identity is desired. Biometric data may also be acquired and processed.

If a user selects a patron and then indicates “Assign ID,” a new identification number may be assigned to the patron. Sub-menus (not shown) may allow the user to indicate a category or rank for the player. Once the patron has been assigned an ID, the player may be tracked in real time, descriptions added to the patron's thread, etc.

FIG. 3D reveals some choices provided to the user by “View” menu 330. In this example, the “Select Camera” feature allows a player to select a different camera for the view shown in area 305. In some casinos, there may be multiple cameras that have the same general area in their fields of view. Some view points may become more useful if, for example, that area of the casino becomes crowded and the view of certain patrons of interest becomes obscured from the viewpoint of another camera. The “Orient Camera” and “Zoom In/Out” features may help a user view patrons and activities of interest, as well as providing details regarding a patrons' preferences that may not be visible without zooming in. The “Re-Size Window(s)” option allows the user to change the size of displayed windows, including but not limited to areas 305, 310 and 315.

As discussed in more detail in the “Real-Time Player Tracking” application, which has been hereby incorporated by reference, some implementations of the invention allow a user to view the prior activities of a patron of interest. Moreover, some implementations of the invention provide the ability to gather, analyze and store patron event data pertaining to activities that occurred prior to the detection of a high-roller indicium or prior to the determination of a defined event. Certain types of event data may be acquired and stored, at least temporarily, even for patrons that have not yet been identified as having special value to a casino. For example, images may be acquired for all patrons within the range of cameras 132 and stored for a predetermined period of time. If a high-roller indicium is detected or a defined event is determined, activities that occurred prior to the detection and/or determination may be evaluated according by reference to such stored data. Patron event data of interest may be associated with a patron and stored.

Here, “View History” allows a user to select a patron and view his or her past activities. For example, a user may select a patron displayed in area 305 or area 310, e.g., by touching the patron's image on the screen, by positioning a cursor over the image and pressing an “Enter” button or the like, etc. According to the implementation, the patron may be selected prior to or after selecting the “View History” feature. In some implementations, the user will then be prompted as to the details, e.g., the type of view desired (e.g., a video camera view such as that displayed in area 305, a path view such as that displayed in area 310, both, etc.), how much time to view, whether to view the patron's activities going forward or backward, etc.

In one such example, if the user were to select whale W097 and the “View History” feature, the user would have the option of viewing the prior activities of this patron, even prior to the time that whale W097 entered the currently-displayed field of view. The patron's path data, thread data and/or display data could be spliced together in order to provide a depiction of the activities of whale W097 over a prior time interval. The user may, for example, choose to “rewind” a video display that includes the patron. Alternatively, the user may decide to skip back an indicated time interval and view the patron's activities. The user may have the option of selecting times associated with descriptions in the patron's thread, because each such description is preferably associated with a time stamp. Preferably, the user would have the option of adding descriptions to the replayed video.

As depicted in FIG. 3E, the “Search” menu 335 provides options for searching different types of player data. Here, by selecting “Descriptions,” a user may search through descriptions that have previously been associated with a patron. In some such implementations, the user may be asked to indicate a time window, a number of casino visits, descriptive data of interest or some other parameter(s) germane to the search. For example, the user may wish to view all instances when the patron was observed to wager at least a threshold amount during the past year. If the audiovisual data associated with such descriptions was stored and has not been deleted, the user may be presented with the option of viewing these data.

As noted elsewhere herein, such audiovisual data may or may not be retained for a long period of time. The retention times for such data may vary according to the classification of the player. For example, audiovisual data pertaining to whales may be retained for a longer time that audiovisual data pertaining to low-level members of a player loyalty program. However, descriptions may be retained for a longer time. Because descriptions should not require as much storage space as audiovisual data, descriptions are a relatively more efficient mode of retaining patron information.

The “Other Data” option may allow a user to search one or more databases to determine other types of information regarding a patron of interest. For example, the user may be able to search a player loyalty database, another casino-related database (such as a retail database, a hotel database, a food/beverage database, a performance database, etc.), a public database, the Internet, etc. The “Current Ranking” option allows a user to determine a patron's current ranking. In some implementations, this information may be part of a player's tracking thread. However, a patron's ranking may change, even during a single casino visit or a single gaming session, depending on other patrons' activity, the frequency of re-ranking, etc.

FIG. 3F reveals some examples of functionality relating to descriptions and/or player tracking threads. “Comment” menu 340, for example, allows a user to select a patron and to edit the patron's tracking thread, e.g., by adding a description of the patron's activity. (The terms “comment” and “description” are used synonymously herein.) Preferably, such descriptions have associated time stamps for convenient association with the video data.

Moreover, the user may enable or disable automated comment-producing systems. For example, if a device determines that a defined event has taken place, the device (or another device) may automatically form a description of the defined event, include a time stamp and add the description to the patron's tracking thread. Such features allow descriptions to be conveniently added to video files associated with a patron. Descriptions not only provide content, but can also form the basis for enabling effective and efficient searching, filtering and browsing of audiovisual data content.

Some such implementations of the invention operate according to the Moving Picture Experts Group (“MPEG”) “MPEG-7” standard. The MPEG-7 standard, also called the “Multimedia Content Description Interface,” provides a set of tools for describing multimedia content. Both human users and automatic systems that process audiovisual information are within the scope of MPEG-7. MPEG-7 offers a comprehensive set of audiovisual Description Tools (defined by the MPEG-7 standard in the form of Descriptors and Description Schemes) to create descriptions. More information about MPEG-7 can be found at the MPEG website (http://www.chiariglione.org/mpeg), the MPEG-7 Industry Forum website (http://www.mpegif.com), and the MPEG-7 Consortium website (http://mpeg7.nist.gov), all of which are hereby incorporated by reference.

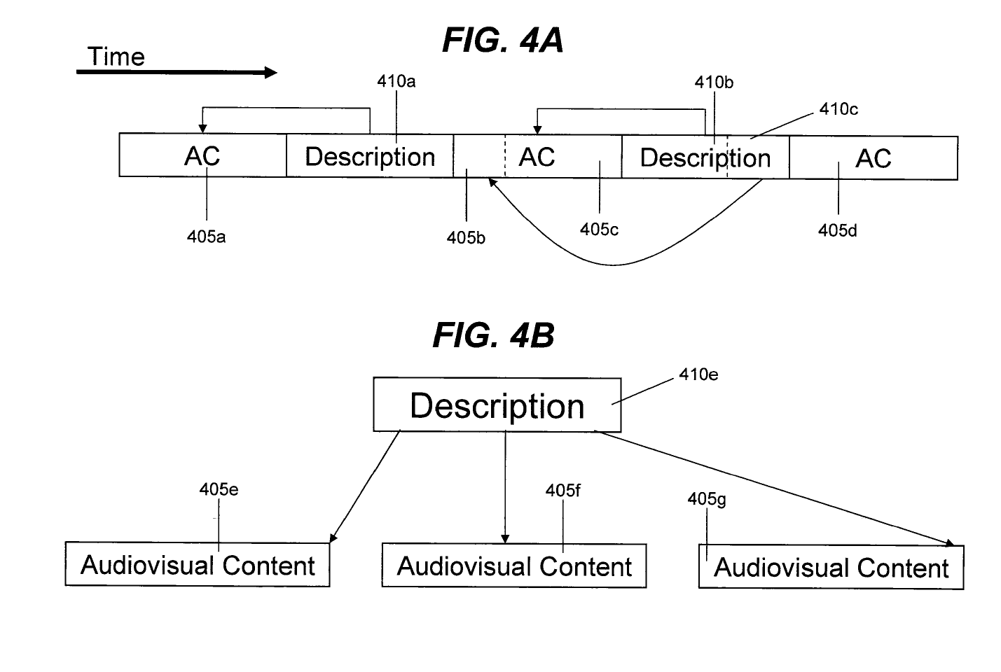

According to the MPEG-7 specification, descriptions may be associated with video files in at least two ways, as shown by FIGS. 4A and 4B. In FIG. 4A, segments 405 of audiovisual content and segments 410 of descriptive data are stored in a string. In this example, the audiovisual content is organized in chronological order. Here, description 410a relates to audiovisual content 405a.

However, the descriptive data segments 410 may or may not be assembled precisely in order, because the descriptive data segments 410 have associated time stamps. For example, descriptive data segment 410b relates to audiovisual content segment 405c and descriptive data segment 410c relates to audiovisual content segment 405b, even though content segment 405c relates to a time later than that of content segment 405b.

In fact, as shown in FIG. 4B, the use of time stamps may allow the descriptive data to be stored separately from the audiovisual data. Here, a plurality of descriptions 410e is stored in one data structure. Some of the descriptions 410e relate to audiovisual content segments 405e, 405f and 405g, which are stored in one or more other data structures. In this example, the descriptions 410e include not only time stamps, but also pointers to the appropriate memory locations for audiovisual content segments 405e, 405f and 405g.

Referring now to FIG. 3G, some features enabled by “Action” menu 345 will now be described. A user may select a patron and then indicate the desired action. For example, a user may indicate an action in response to detecting a defined event associate with a patron. (Step 230.) Such actions may involve providing a higher level of service to the patron and/or indicating that the patron should be assigned a higher rank.

Some actions may require the cooperation of one or more other people, e.g., cooperation of other casino staff. Accordingly, menu 345 provides a method of relaying information to others in the casino, such as bartenders, staff walking the casino floor, staff working in retail, at a restaurant or club, security staff, etc. In addition to text messages or the like, a user may provide the patron's location, path, thread data and/or image data, if so desired. For example, the user may send a message to the nearby bar indicating the favorite beverage of whale W097 and requesting that someone put a drink in his hand ASAP.

FIG. 5 indicates some additional methods that may be performed according to the present invention. The steps of method 500 may be performed by one or more devices, such as a smart camera, a host device and/or a server. As noted elsewhere herein, it may often be the case that a patron will be in the field of view of more than one camera. First, a patron is selected for tracking by an operator viewing images from one camera, referred to as the “current user's camera” or the like. (Step 501.) Although this camera is called the current user's camera in this example, in some implementations, the process may be fully automated; there may or may not be a user associated with the camera.

In this example, the patron's location and/or trajectory are then determined. (Step 505.) Based on the location, it is then determined what other cameras, if any, include the person within their field of view. (Step 507.) In step 510, it is determined whether the other camera(s) is/are tracking the patron. If it does not appear that the patron is already being tracked by another camera, an attempt may be made to identify the patron, e.g., as described above with reference to step 205 of FIG. 2.

However, if it appears that the patron is already being tracked by another camera, it may be determined whether there is an indication to hand off tracking operations to the current user's camera. (Step 515.) For example, according to the patron's current trajectory, it may appear that the patron will soon be outside another camera's field of view. The current user, the current user's camera, another camera and/or another device may determine that the tracking operation should be handed off to the current user's camera. If so, tracking thread data, etc., will be received from another camera, from a server or another device. (Step 520.) The process may proceed in a manner indicated in FIG. 2, continuing with step 215.

Even if there is no handoff indication, there may be an indication for more than one camera, including the current user's camera, to track the patron in real time. (Step 525.) For example, the current user (or another user or device) may determine that the patron is sufficiently interesting to be tracked by more than one camera and/or that the viewpoint of the current user's camera will be advantageous in some way. One of the users may, for example, make this indication using a viewing option menu of a GUI similar to that described above. If so, tracking thread data, etc., will be received from another camera, from a server or another device. (Step 530.) The process may proceed in a manner indicated in FIG. 2, e.g., continuing with step 215. If not, the process may end. (Step 535.) Alternatively, the process may continue to one of the previous steps, e.g., step 505.

Method 600 (see FIG. 6) involves the acquisition of varying levels of facial recognition data, according to a player's rank, the level of interest in a player, etc. Such implementations may be advantageous because high-value patrons will be easier to identify automatically, even if such patrons are not using a player loyalty device. In this example, when a patron approaches a gaming establishment (step 605), it is determined whether the player can be identified according to a “known location device” such as an RFID device that the gaming establishment can recognize as being associated with the player, a mobile gaming device, a GPS-enabled device, etc. If so, little or no facial recognition data are obtained (step 630), because the player can be both identified and tracked without reference to such data.

If the player does not carry a known location device, it is determined whether the player is a potential high roller, e.g., as described above. (Step 615.) For example, if the known location device is an RFID device associated with the gaming establishment's player loyalty and/or player tracking program, the player's automobile, jewelry, etc., may not require careful scrutiny because a great deal may already be known about the player.

In some implementations, however, step 615 may be performed even if the player has a known location device. The evaluation underlying step 615 may still be fruitful in some instances: such an evaluation may indicate recent expenditures that signal a change in the patron's fortunes and/or a change in the patron's spending habits. Moreover, such information may be useful in determining characteristics of groups and/or sub-groups, e.g., of a player loyalty program. For example, players of a certain level (e.g., gold members) may be considered a “group” and players in that level who are of a certain age range may be considered members of a “sub-group.” Acquiring data about expenditures, interests, trends, etc., of such groups and sub-groups may allow a gaming establishment to define trends that may be used to generate player interest, target marketing efforts, etc.

In this example, if insufficient high-roller indicia are detected in step 615, a standard level of facial recognition data will be acquired. (Step 625.) The type and quantity of data in a “standard level of facial recognition data” is preferably determined by the gaming establishment; various reasonable metrics may be established within the scope and spirit of the invention. For example, enough 2D facial recognition data may be acquired to acquire a “faceprint” according to facial recognition software used by a gaming establishment. Establishing such a “standard level of facial recognition data” may allow a reasonable chance of recognizing and locating the patron if it becomes desirable to do so. As before, an ID is preferably assigned to unidentified patrons, in order to allow the facial recognition data to be associated with these patrons.

If sufficient high-roller indicia are detected, a relatively higher level of facial recognition data may be acquired. (Step 620.) For example, sufficient image data may be acquired for 3D facial imaging methods and/or for methods that compensate for skin type, as described elsewhere.

In this example, the patron will be rank/categorized according to the available data (step 635) and monitored, e.g., according to the patron's category. (Step 640.) Responses will be provided, preferably according to the patron's category, but also preferably according to known preferences of the patron and/or information regarding the patron that may suggest such preferences. (Step 645.)

Various types of ranking and/or classification schemes may be employed, some of which are described in detail herein. A simple classification scheme may place all patrons into one of two categories: (1) patrons worth the dedication of resources; and (2) patrons not worth the dedication of resources.

However, alternative implementations of the invention may include multiple gradations of patrons who are deemed to be worth the dedication of resources. For example, there could be N categories of patrons deemed to be worth the dedication of resources, with different amounts of resources that are potentially available to and/or directed towards a patron.

FIG. 1A illustrates one such implementation, wherein N=2. Patrons 166a, 166b, 166c and 166d are placed in the highest category. Here, companion 168a of patron 166a and companion 168b of patron 166b are also placed in the highest category. Patrons 164 (two of whom may be seen in auditorium 124) are in the second-highest category. In this example, only patrons in these two categories will receive special services, directed marketing, etc.

In this example, patron 166c has previously been identified as a high-level patron according to a defined event and a ranking/categorization process. When it is determined that high-level patron 166c is having a drink at bar 122, the beverage preferences of patron 166c are noted in real time, are associated with the patron ID code of patron 166c and are stored as patron data in a player loyalty database. Moreover, the game preferences of patron 166c are determined (e.g., by reference to the player loyalty database). Gaming machine 127c is configured accordingly (e.g., by a server in control room 128). In some implementations of the invention, multiple nearby gaming machines (e.g., the bank of gaming machines that includes gaming machine 127c) may be configured according to the preferences of a group of patrons (e.g., patron 166c and other patrons nearby). Special promotions (or other responses) may be directed to patron 166c via gaming machine 127c or otherwise, e.g., via a mobile device such as a PDA, a mobile gaming device, a cellular telephone, etc., associated with patron 166c. Preferably, the promotion is tailored according to information regarding the preferences, or at least the demographics, of patron 166c.

In this example, it is observed that high-level patron 166b and companion 168b are at the entrance of restaurant 114. The staff of restaurant 114 is notified that patron 166b and companion 168b should be provided with top-level service. This notification may occur in any convenient fashion, e.g., via cellular phone, PDA, host device 142, etc. For example, patron 166b and companion 168b may be seated even if they do not have a reservation and restaurant 114 is very busy. They may be provided with free drinks while their table is being prepared. Their food and beverage selections may be noted in real time, associated with their patron ID codes and stored as patron data.

Similarly, when a high-level patron or companion is observed in or near a shop, their purchase types, amounts, etc., may be noted in real time, associated with their patron ID codes and stored as patron data. High-level service, discounts, free shipping, etc., may be provided. For example, patron 166d purchased chocolates for a friend at candy store 108. The amount and type of this purchase was noted in real time, associated with her patron ID code and stored as patron data. Patron 166d was pleased when candy store 108 shipped the chocolates to her friend at no charge. When a high-level patron or companion is observed to be leaving the gaming establishment, he or she may be given a special farewell.

Patrons 164 (two of whom may be seen in auditorium 124) are in the second-highest category. In this implementation, patrons in second-highest category will also receive an elevated level of customer service as compared to the average patron. A more moderate level of patron data will be acquired for in the second-highest category.

Although the terms “rank” and “category” may sometimes be used synonymously, in some implementations of the invention the terms may have different meanings. In such implementations, a “category” corresponds to a level of resources that a gaming establishment may potentially direct towards a patron according to method of the invention. As used herein, the term “resources” is used to include time, effort, services, comps, money, etc. In some implementations, the level of resources corresponding with a category may be zero, but this does not mean that a patron will receive, e.g., no service or poor service. Instead, it means that the no additional resources, over and above the normal level of service, amenities, etc., will be provided according to the present invention.

Moreover, there may be several ranks that correspond with a category. In one such example, the top five patrons (ranks 1 through 5) may be placed in the highest category, the patrons ranked 6^{th} through 20^{th} may be placed in the next (lower) category, etc.

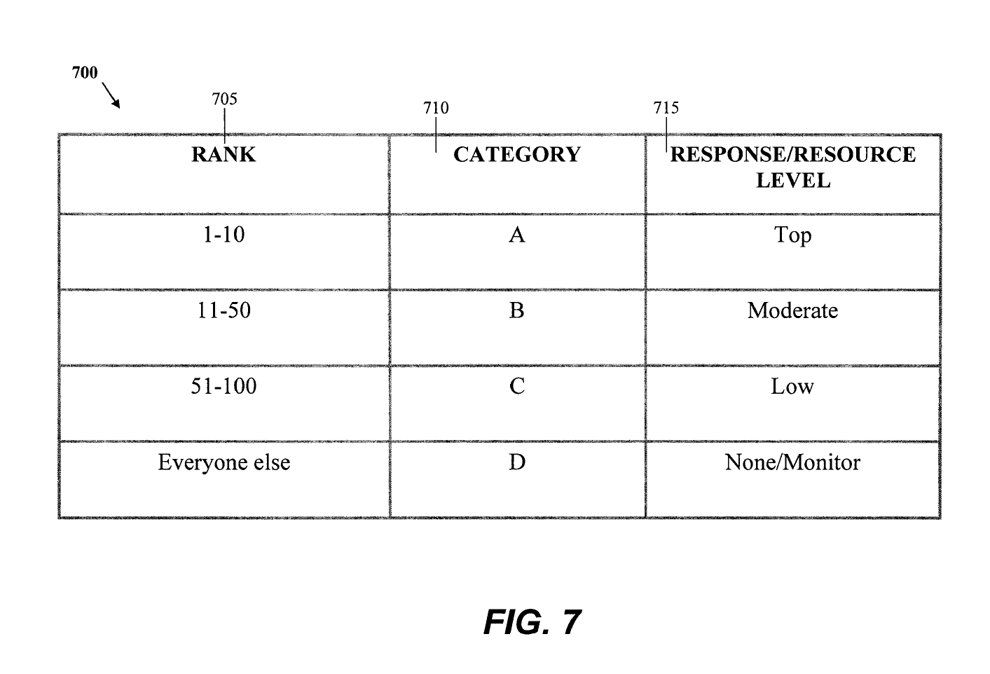

A similar example is illustrated in FIG. 7. Table 700 sets forth ranks 705, categories 710 and response levels 715 according to one implementation of the invention. In this example, the top ten patrons (ranks 1 through 10) are placed in the highest category, “A,” which corresponds to the highest response level. The patrons ranked 11^{th} through 50^{th} are placed in the next category “B,” which corresponds to a moderate response level. Patrons ranked 51^{st} through 100^{th} are placed in category “C,” which corresponds to a lower response level. All other patrons are placed in category “D” unless and until their status changes.

However, in some implementations, there may be a different level of available resources corresponding to each rank. In such implementations, a rank is equivalent to a category.

In still other implementations, there is no fixed number of patrons for at least some of the categories. For example, a patron of the player loyalty and/or player tracking program of a gaming establishment may always be entitled to receive (or at least potentially receive) a predetermined level of resources, regardless of the number of other patrons present. In such implementations, a patron who is ranked at the highest level of such a player loyalty and/or player tracking program might always be in category “A” of FIG. 7. Similarly, an anonymous patron who is ranked in a predetermined level according to predetermined criteria/metrics may always be placed in a corresponding category.

Alternatively, or additionally, the number of anonymous patrons present to whom resources will be directed will depend on the number of patrons present who are in a gaming establishment's player loyalty and/or player tracking program. For example, if there are 8 patrons present who are ranked at the highest level of a casino's player tracking program and 30 additional players present who are ranked at the second-highest level of the casino's player tracking program, only 2 anonymous patrons would be eligible to be in category “A” of FIG. 7 and only 10 more anonymous patrons would be eligible to be in category “B.” Anonymous patrons who would otherwise have been placed in category “A” may, for example, be placed in category “B,” to the extent that space is available.

As noted above, some implementations of the invention provide for an earlier ranking process (e.g., at step 615 of FIG. 6), which may be a preliminary ranking process based on first impressions. Accordingly, a threshold determination as to which patrons are worth the dedication of resources, such as the targeting of marketing efforts, may already have been made. However, in some implementations of the invention (as here), patron ranking is a dynamic process.

Some implementations involve tracking a patron's activities to determine various preferences, which may include gaming preferences or other preferences. For example, the time of day a patron likes to gamble, drink, shop, etc., what wagering games the patron prefers, etc., may be tracked. These data will provide information about what types of offers the patron may be interested in receiving at a particular time of day, day of the week, etc. Moreover, a patron's habits may also be used to verify a tentative identification based on other factors. For example, if there is a strong likelihood of a facial image match and other such data also match a patron's previously-observed habits, this provides a higher likelihood of correct patron identification.

Such information may be associated with a patron ID code and stored in one or more data structures. Moreover, some such information may be added as MPEG-7 descriptions and associated with audiovisual data obtained regarding the patron.

Gaming and/or non-gaming activity of all patrons may be monitored to some degree, even in implementations such as that described with respect to FIG. 7, wherein no special response will be made to patrons having the lowest ranking. However, the degree of monitoring may vary considerably, e.g., according to a patron's category. A flexible approach to patron monitoring may be important, particularly if patrons cannot easily be monitored in a fully automated fashion, e.g., via an RFID network, by GPS, by triangulation (e.g., of a PDA, a cellular telephone or a mobile gaming device), by using a network of near-field magnetic devices, etc. Monitoring by facial recognition techniques may require a combination of automated processes and human involvement, and may therefore be more resource-intensive.

More extensive and careful monitoring may be desired for patrons in a high-level category: such patrons' location and/or activities may need to be closely monitored in order that a high level of service and other such resources are directed to the intended patrons. Such patrons may be monitored even by resource-intensive methods, if necessary.

In contrast, the level of “monitoring” for patrons in, e.g., category D of FIG. 7 may involve, e.g., only events that may indicate that a patron should be considered for a higher category. For example, if a category D patron were to order an expensive bottle of wine at restaurant 114, this may be considered a “high roller indicium” indicium (step 655) trigger a re-evaluation of the patron's rank. (Step 635). However, in some implementations, even the locations of category D patrons (or the like) will be tracked, e.g., if doing so will not consume a disproportionate level of resources. For example, if the locations of such patrons may be tracked by an RFID network, it may be done.

Responses will be provided to patrons (or not) according to their category, which may change over time, as well as other factors. (Step 645.) To the extent that responses will be provided, they are preferably not only according to the patron's category, but also according to known preferences of the patron and/or information regarding the patron that may suggest such preferences, including but not limited to demographic data. For patrons who are identified, some such preference data may be determined from player loyalty and/or player tracking databases, other gaming establishment-related databases, or publicly available databases.

Depending on the amount of data to be evaluated and potentially stored regarding patrons, it may be advantageous to store data in a dimensional database structure. Multi-dimensional database achieve performance levels that are well in excess of that of relational systems performing similar data storage requirements. These high performance levels encourage and enable On Line Analytical Processing (“OLAP”) and other such applications that can provide the ability to analyze large amounts of data with very fast response times.

Other preference data may be based on observations of the patron and/or the patron's activities. If a patron is seen to be wearing a hat or garment with a NASCAR-related logo, for example, offers relating to a NASCAR-related event may be directed to the patron. The degree to which such observations and/or responses are made will preferably be based upon a patron's category, in order to maintain a reasonable relationship between the resources directed towards the patron and the patron's likely value to the gaming establishment.

If there are subsequent indications that a patron in a lower category should be re-categorized (e.g., as determined in step 655), it will also be determined whether there are adequate facial recognition data for the patron. (Step 660.) If not, such data are acquired. (Step 665.) For example, acquiring additional facial recognition data (and/or a higher level of facial recognition data) may allow a positive identification of the player, which in turn may reveal player preferences, indications of financial/economic/spending data, etc., from one or more public or private databases. Moreover, acquiring a higher level of facial recognition data may allow a patron to be monitored more easily, thereby allowing accurately targeted responses.

If the patron engages in activities that indicate that the patron has spent (or may spend) a significant amount of money (step 655), the patron's rank and/or category may change. (Step 635.)

When the patron leaves the gaming establishment (as determined in step 650), the process ends. (Step 670.) Preferably, the patron should no longer be included in a pool of patrons eligible for directed resources: the patron's ID may be deleted from a list of patrons currently in the gaming establishment. In some implementations, if the patron had been ranked, e.g., as a category “A” patron, the patron's departure could trigger a re-ranking of patrons still thought to be in the gaming establishment.

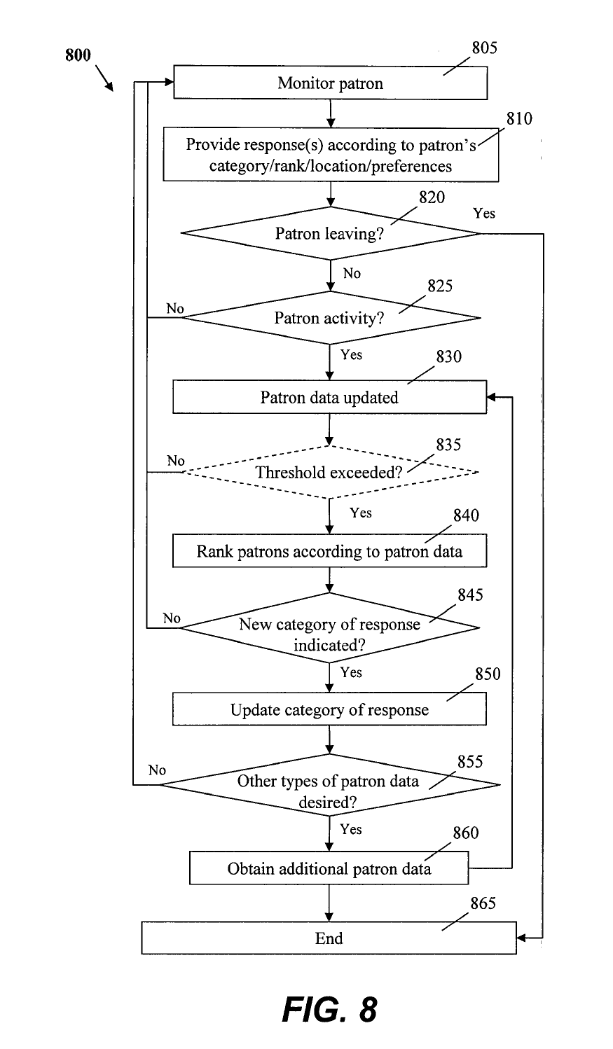

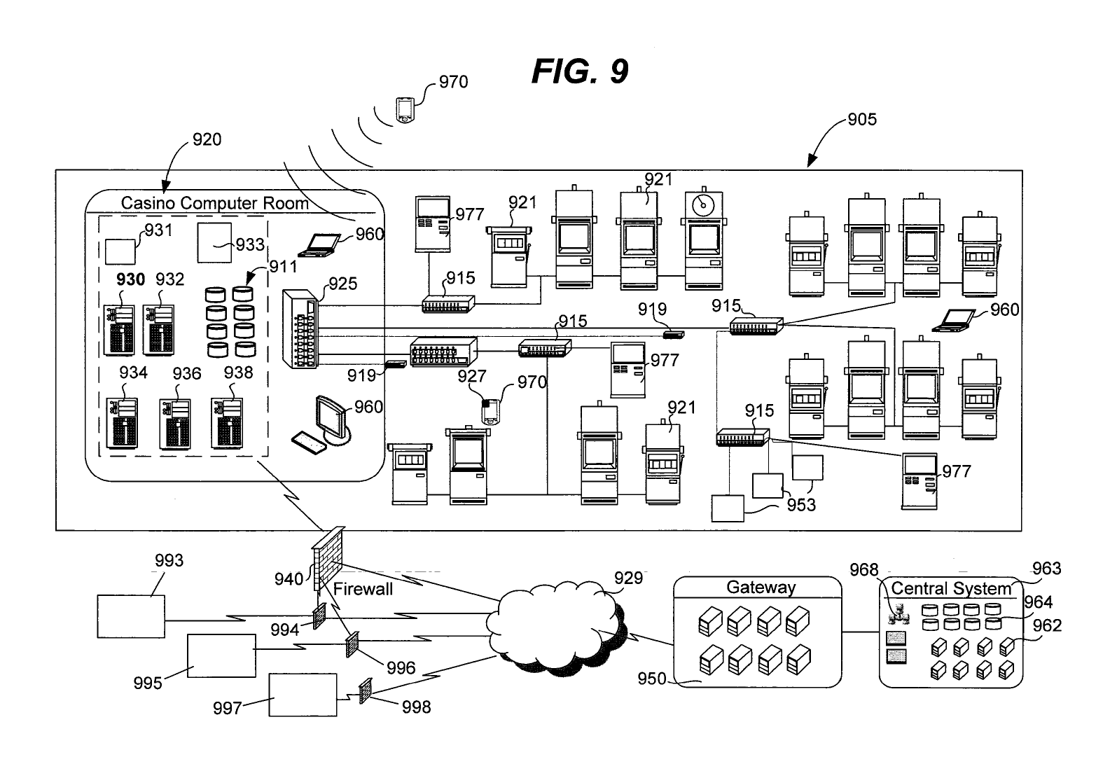

FIG. 8 outlines some steps of method 800, which indicates further details regarding a process of ranking and categorizing a patron according to some implementations of the invention. In step 805, a patron is being monitored. In this example, the patron has already entered a gaming establishment and has either been identified or at least has an assigned code or the like, in order to allow patron data to be associated with the patron and/or responses to be directed to the patron (step 810), if desired. As before, the process ends (as to that patron) when a patron leaves. (Steps 820 and 865.)

In step 825, it is determined whether there has been some form of patron activity that may potentially affect a patron's rank and/or category. For example, the patron may have been observed shopping in an expensive shop, e.g., for high-end jewelry, watches, clothing, etc. An actual purchase of an expensive item, an expensive dinner, wine or other drinks, registering to stay in a luxury suite at the hotel, high-stakes wagering, or any other predetermined metric may cause a positive indication for step 825.

The patron's data will be updated, as appropriate. (Step 830.) In some implementations, a point-based system is applied to activities pertaining to step 825. In some such implementations, the number of points is proportional to the amount of money spent. Gaming and non-gaming activities may be treated as being equally significant in some implementations, but not in others. For example, a given amount wagered may be assigned a higher (or lower) point value than the same amount spent on a bottle of wine. In some implementations, even browsing in or near a high-end shop can result in the award of points.

In some implementations of the invention, the accumulated points may be loyalty points of a patron loyalty system such as that described above with reference to FIG. 3 et seq., wherein points accumulated by patrons for both gaming and non-gaming activities may be redeemed upon demand by the patrons for goods and services. Such a program may be referred to herein as a “casino enterprise point system” or the like. As described above, some implementations do not require patrons to enroll in a player loyalty program; points may be accumulated and redeemed anonymously. However, as noted above, such a program may include not only gaming and non-gaming activities in a particular gaming establishment, but also purchases (or other activities) in affiliated businesses at other sites. For gaming operators whose enterprises span multiple jurisdictions, the system should differentiate clearly unique jurisdictional requirements and isolate locations that do not allow certain types of promotions or features.

Preferably, points may be awarded in a flexible manner that may be tailored by a gaming establishment. A particular gaming establishment may choose to award more (or fewer) points for each dollar spent in a hotel or in a shop than wagered in a casino. For example, at certain times a gaming establishment may create incentives for patrons to patronize targeted portions of a casino. At such times, patrons may accumulate points in a particular shop, restaurant, entertainment venue, etc., at a higher rate than during other times. A gaming establishment may encourage participation in a jackpot or the like by allowing a patron to qualify for the jackpot by participating in various activities in addition to putting money in gaming machine, such as spending money in a retail location, buying a meal and/or a drink, making a purchase from a hotel room, playing a game from a hotel room, etc. A particular gaming establishment may desire to change point accumulation criteria based on various criteria, such as time of day, time of year (e.g., holidays), during special events (e.g., NASCAR weekend) or conferences, spend rates, patron rank/category, target spending criteria, etc.

According to method 800, each event that may change a patron's status may not necessarily trigger a re-assessment of patron ranking. In this example, it is determined whether a threshold is exceeded before such a re-ranking process is triggered. (See optional step 835.) The threshold may be relative (e.g., to a last point total of a patron) or absolute (e.g., with reference to “break points” between categories of patrons and/or levels of a player loyalty and/or player tracking program). The threshold(s) may be dynamically adjustable, e.g., to prevent re-ranking processes from being initiated too frequently when a gaming establishment is busy.

If such a threshold is exceeded, the patrons are re-ranked. In this example, there are multiple rankings within at least some categories (e.g., as described with reference to FIG. 7). Therefore, it is then determined whether the re-ranking process has resulted in a change in category for one or more patrons. (Step 845.) If so, the category is updated in step 850.

In step 855, it is determined whether other types of patron data are now desirable, in view of a change in patron category. For example, if a patron was previously in a lower category (e.g., category C or D of FIG. 7) and has been re-classified in a sufficiently higher category (e.g., category A or B of FIG. 7), it may now be worth making a more concerted effort to identify a patron and/or search databases for spending, preference and other information regarding the patron. If the patron has not previously been identified, a preliminary step may be the acquisition of additional biometric data. (Step 860.) For example, image data suitable for a 3D facial recognition process may be acquired and the 3D facial recognition process may be invoked.

If additional patron data are acquired, they are associated with the patron and stored. (Step 830.) Such data may be used in both a monitoring process (step 805) and to determine appropriate responses for a patron. (Step 810.)

Some networks described herein provide methods and devices for managing one or more networked gaming establishments. Such networks may sometimes be referred to herein as server-based gaming networks, sb™ networks, or the like. Some such gaming networks described herein allow for the convenient provisioning of networked gaming machines and other devices relevant to casino operations. Game themes may be easily and conveniently added or changed, if desired. Related software, including but not limited to player tracking software, peripheral software, etc., may be downloaded to networked gaming machines and other devices, such as kiosks, networked gaming tables, player stations, etc.

Relevant information is set forth in U.S. patent application Ser. No. 11/225,407 (Attorney Docket No. IGT1P237/P-1051), by Wolf et al., entitled “METHODS AND DEVICES FOR MANAGING GAMING NETWORKS” and filed Sep. 12, 2005, in U.S. patent application Ser. No. 10/757,609 by Nelson et al., entitled “METHODS AND APPARATUS FOR GAMING DATA DOWNLOADING” (Attorney Docket No. IGT1P213/P-657) and filed on Jan. 14, 2004, in U.S. patent application Ser. No. 10/938,293 by Benbrahim et al., entitled “METHODS AND APPARATUS FOR DATA COMMUNICATION IN A GAMING SYSTEM” (Attorney Docket No. IGT1P199/P-909) and filed on Sep. 10, 2004, in U.S. patent application Ser. No. 11/225,337 (Attorney Docket No. IGT1P185/P-1017) by Nguyen et al., filed Sep. 12, 2005 and entitled “DISTRIBUTED GAME SERVICES,” in U.S. patent application Ser. No. 11/225,408 (Attorney Docket No. IGT1P253) by Kinsley et al., entitled “METHODS AND DEVICES FOR AUTHENTICATION AND LICENSING IN A GAMING NETWORK” and filed Aug. 1, 2005, in U.S. patent application Ser. No. 11/078,966 (Attorney Docket No. IGT1P034X2/P-277 CIP2) by Nguyen et al., filed Mar. 10, 2005 and entitled “SECURED VIRTUAL NETWORK IN A GAMING ENVIRONMENT,” in U.S. patent application Ser. No. 11/173,442 (Attorney Docket No. IGT1P153/P-991) by Kinsley et al., filed Jul. 1, 2005 and entitled “METHODS AND DEVICES FOR DOWNLOADING GAMES OF CHANCE” and in U.S. patent application Ser. No. 11/810,888 (Attorney Docket No. IGT1P390/P-1200) by Graham et al., filed Jun. 6, 2007 and entitled “DATABASE QUERIES WITHIN A GAMING MACHINE,” all of which are hereby incorporated by reference in their entirety and for all purposes.

Some such networks include devices that provide functionality relating to the present invention. For example, information may conveniently be collected from networked devices, including but not limited to cameras, RFID readers, gaming machines, etc. Such devices, and other devices, may be controlled by servers, host devices, etc., to further the objects of the invention. For example, a camera may be controlled to zoom in and/or higher-resolution images may be acquired for a particular patron of interest. One or more of servers, host devices, cameras or other devices may be configured with software for patron identification, patron tracking, event detection and/or making responses thereto.

One example of an sb™ network is depicted in FIG. 9. Those of skill in the art will realize that this architecture and the related functionality are merely examples and that the present invention encompasses many other such embodiments and methods. Moreover, other devices that may be used in connection with the present invention do not appear in FIG. 9. For example, a network for implementing the present invention would preferably include a plurality of networked cameras, such as video cameras, smart cameras, digital still cameras, etc., such as those described above with reference to FIGS. 1A through 1D. Moreover, a network for implementing the present invention may also include various RFID readers, RFID switches, middleware servers, etc.

Here, casino computer room 920 and networked devices of a gaming establishment 905 are illustrated. Gaming establishment 905 is configured for communication with central system 963 via gateway 950. Gaming establishments 993 and 995 are also configured for communication with central system 963.

In some implementations, gaming establishments may be configured for communication with one another. In this example, gaming establishments 993 and 995 are configured for communication with casino computer room 920. Such a configuration may allow devices and/or operators in casino 905 to communicate with and/or control devices in other casinos. In some such implementations, a server in computer room 920 may control devices in casino 905 and devices in other gaming establishments. Conversely, devices and/or operators in another gaming establishment may communicate with and/or control devices in casino 905.

For example, a server of casino 905 or central system 963 may be provisioned with relatively more advanced software (e.g., 3-D facial recognition software) for patron identification than servers of other networked locations. Such a server may process patron identification requests from devices in casino 905 as well as patron identification requests from devices in gaming establishments 993 and 995.

Here, gaming establishment 997 is configured for communication with central system 963, but is not configured for communication with other gaming establishments. Some gaming establishments (not shown) may not be in communication with other gaming establishments or with a central system.

Gaming establishment 905 includes multiple gaming machines 921, each of which is part of a bank 910 of gaming machines 921. In this example, gaming establishment 905 also includes a bank of networked gaming tables 953. However, the present invention may be implemented in gaming establishments having any number of gaming machines, gaming tables, etc. It will be appreciated that many gaming establishments include hundreds or even thousands of gaming machines 921 and/or gaming tables 953, not all of which are necessarily included in a bank and some of which may not be connected to a network.

Some gaming networks provide features for gaming tables that are similar to those provided for gaming machines, including but not limited to bonusing, player loyalty/player tracking and the use of cashless instruments. Relevant material is provided in U.S. patent application Ser. No. 11/154,833, entitled “CASHLESS INSTRUMENT BASED TABLE GAME PROMOTIONAL SYSTEM AND METHODOLOGY” and filed on Jun. 15, 2005 (attorney docket no. IGT1P035×3), U.S. Provisional Patent Application No. 60/858,046, entitled “AUTOMATED PLAYER DATA COLLECTION SYSTEM FOR TABLE GAME ENVIRONMENTS” and filed on Nov. 10, 2006 (attorney docket no. IGT1P061X5P), U.S. patent application Ser. No. 11/129,702, entitled “WIDE AREA TABLE GAMING MONITOR AND CONTROL SYSTEM” and filed on May 15, 2005 (attorney docket no. IGT1P115), U.S. patent application Ser. No. 11/425,998 entitled “PROGRESSIVE TABLE GAME BONUSING SYSTEMS AND METHODS”, filed Jun. 22, 2006 (attorney docket no. IGT1P238/P-1049) and U.S. patent application Ser. No. 11/225,299, entitled “UNIVERSAL CASINO BONUSING SYSTEMS AND METHODS” and filed on Sep. 12, 2005 (attorney docket no. IGT1P243), all of which are incorporated herein by reference. Accordingly, software related to such features may be provided and/or controlled, and related data may be obtained and/or provided, according to the present invention.

Some configurations can provide automated, multi-player roulette, blackjack, baccarat, and other table games. The table games may be conducted by a dealer and/or by using some form of automation, which may include an automated roulette wheel, an electronic representation of a dealer, etc. In some such implementations, devices such as cameras, radio frequency identification devices, etc., may be used to identify and/or track playing cards, chips, etc. Some of gaming tables 953 may be configured for communication with individual player terminals (not shown), which may be configured to accept bets, present an electronic representation of a dealer, indicate game outcomes, etc.

Some gaming networks include electronically configurable tables for playing table games. U.S. patent application Ser. No. 11/517,861, entitled “CASINO DISPLAY METHODS AND DEVICES” and filed on Sep. 7, 2006 (attorney docket no. IGT1P106×2), describes some such tables and is hereby incorporated by reference. An operator may select a desired game, such as a poker game or a blackjack game, and the table will be automatically configured with geometrical patterns, text, etc., which are appropriate for the desired table game. The desired type of table game may be selected by a control on the table itself or according to instructions received from, e.g., a server or a casino manager via a network interface.

Gaming establishment 905 also includes networked kiosks 977. Depending on the implementation, kiosks 977 may be used for various purposes, including but not limited to cashing out, prize redemption, redeeming points from a player loyalty program, redeeming “cashless” indicia such as bonus tickets, smart cards, etc. In some implementations, kiosks 977 may be used for obtaining information about the gaming establishment, e.g., regarding scheduled events (such as tournaments, entertainment, etc.), regarding a patron's location, etc. Software related to such features may be provided and/or controlled, and related data may be obtained and/or provided, according to the present invention.

In this example, each bank 910 has a corresponding switch 915, which may be a conventional bank switch in some implementations. Each switch 915 is configured for communication with one or more devices in computer room 920 via main network device 925, which combines switching and routing functionality in this example. Although various communication protocols may be used, some preferred implementations use the Gaming Standards Association's G2S Message Protocol. Other implementations may use IGT's open, Ethernet-based SuperSAS® protocol, which IGT makes available for downloading without charge. Still other protocols, including but not limited to Best of Breed (“BOB”), may be used to implement various aspects of the invention. IGT has also developed a gaming-industry-specific transport layer called CASH that rides on top of TCP/IP and offers additional functionality and security.

Here, gaming establishment 905 also includes an RFID network, implemented in part by RFID switches 919 and multiple RFID readers (not shown). An RFID network may be used, for example, to track objects (such as mobile gaming devices), patrons, etc., in the vicinity of gaming establishment 905. Some examples of how an RFID network may be used in a gaming establishment are set forth in U.S. patent application Ser. No. 11/655,496, entitled “DYNAMIC CASINO TRACKING AND OPTIMIZATION” and filed on Jan. 19, 2007 (Attorney Docket No. IGT1P082C1X1/P-713 CON CIP) and in U.S. patent application Ser. No. 11/599,241, entitled “DOWNLOADING UPON THE OCCURRENCE OF PREDETERMINED EVENTS” and filed on Nov. 13, 2006 (Attorney Docket No. IGT1P118C1X1/P-303 CON CIP), both of which are hereby incorporated by reference.

As noted elsewhere herein, some implementations of the invention may involve “smart” player loyalty instruments, such as player tracking cards, that include an RFID tag. Accordingly, the location of such RFID-enabled player loyalty instruments may be tracked via the RFID network. In this example, at least some of mobile devices 970 may include an RFID tag 927, which includes encoded identification information for the mobile device 970. Accordingly, the locations of such tagged mobile devices 970 may be tracked via the RFID network in gaming establishment 905. Other location-detection devices and systems, such as the global positioning system (“GPS”), may be used to monitor the location of people and/or devices in the vicinity of gaming establishment 905 or elsewhere.

Various alternative network topologies can be used to implement different aspects of the invention and/or to accommodate varying numbers of networked devices. For example, gaming establishments with large numbers of gaming machines 921 may require multiple instances of some network devices (e.g., of main network device 925, which combines switching and routing functionality in this example) and/or the inclusion of other network devices not shown in FIG. 9. Some implementations of the invention may include one or more middleware servers disposed between kiosks 977, RFID switches 919 and/or bank switches 915 and one or more devices in computer room 920 (e.g., a corresponding server). Such middleware servers can provide various useful functions, including but not limited to the filtering and/or aggregation of data received from switches, from individual gaming machines and from other devices. Some implementations of the invention include load-balancing methods and devices for managing network traffic.

Storage devices 911, sb™ server 930, License Manager 931, Arbiter 933, servers 932, 934, 936 and 938, host device(s) 960 and main network device 925 are disposed within computer room 920 of gaming establishment 905. In practice, more or fewer devices may be used. Depending on the implementation, some such devices may reside in gaming establishment 905 or elsewhere.

One or more devices in central system 963 may also be configured to perform, at least in part, tasks specific to the present invention. For example, one or more servers 962, storage devices 964 and/or host devices 960 of central system 963 may be configured to implement the functions described in detail elsewhere herein. These functions may include, but are not limited to, collecting data from devices (such as cameras, RFID readers, EGMs, cash registers, host devices, mobile devices, etc.), evaluating such data for defined events, determining which patrons may require heightened levels of data gathering and/or service, adding descriptions to audiovisual data associated with such patrons, etc. One or more of the servers of computer room 920 may be configured with software for camera control, patron identification, patron tracking, event detection and/or making responses to detected events.

These servers may be configured for communication with other devices in or outside of gaming establishment 905, such as host devices 960 and mobile devices 970, for implementing some methods described elsewhere herein. Host devices 960 and mobile devices 970, some of which may be associated with computer room 920, may be used to provide the graphical user interfaces and related functionality described above, e.g., with reference to FIGS. 3A through 3G.

Some of these servers may be configured to perform tasks relating to accounting, player loyalty, bonusing/progressives, configuration of gaming machines, etc. One or more such devices may be used to implement a casino management system, such as the IGT Advantage™ Casino System suite of applications, which provides instantaneous information that may be used for decision-making by casino managers. A Radius server and/or a DHCP server may also be configured for communication with the gaming network. Some implementations of the invention provide one or more of these servers in the form of blade servers.

Some preferred embodiments of sb™ server 930 and the other servers shown in FIG. 9 include (or are at least in communication with) clustered CPUs, redundant storage devices, including backup storage devices, switches, etc. Such storage devices may include a “RAID” (originally redundant array of inexpensive disks, now also known as redundant array of independent disks) array, back-up hard drives and/or tape drives, etc.

In some implementations of the invention, many of these devices (including but not limited to License Manager 931, servers 932, 934, 936 and 938, and main network device 925) are mounted in a single rack with sb™ server 930. Accordingly, many or all such devices will sometimes be referenced in the aggregate as an “sb™ server.” However, in alternative implementations, one or more of these devices is in communication with sb™ server 930 and/or other devices of the network but located elsewhere. For example, some of the devices could be mounted in separate racks within computer room 920 or located elsewhere on the network. Moreover, it can be advantageous to store large volumes of data elsewhere via a storage area network (“SAN”).

Computer room 920 may include one or more operator consoles or other host devices that are configured for communication with other devices within and outside of computer room 920. Such host devices may be provided with software, hardware and/or firmware for implementing various aspects of the invention. However, such host devices need not be located within computer room 920. Wired host devices 960 (which are desktop and laptop computers in this example) and wireless devices 970 (which are PDAs in this example) may be located elsewhere in gaming establishment 905 or at a remote location.

Some embodiments of the invention include devices for implementing access control, security and/or other functions relating to the communication between different devices on the network. In this example, arbiter 933 serves as an intermediary between different devices on the network. Arbiter 933 may be implemented, for example, via software that is running on a server or another networked device. Some implementations of Arbiter 933 are described in U.S. patent application Ser. No. 10/948,387, entitled “METHODS AND APPARATUS FOR NEGOTIATING COMMUNICATIONS WITHIN A GAMING NETWORK” and filed Sep. 23, 2004 (the “Arbiter Application”), which is incorporated herein by reference and for all purposes. In some preferred implementations, Arbiter 933 is a repository for the configuration information required for communication between devices on the gaming network (and, in some implementations, devices outside the gaming network). Although Arbiter 933 can be implemented in various ways, one exemplary implementation is discussed in the following paragraphs.

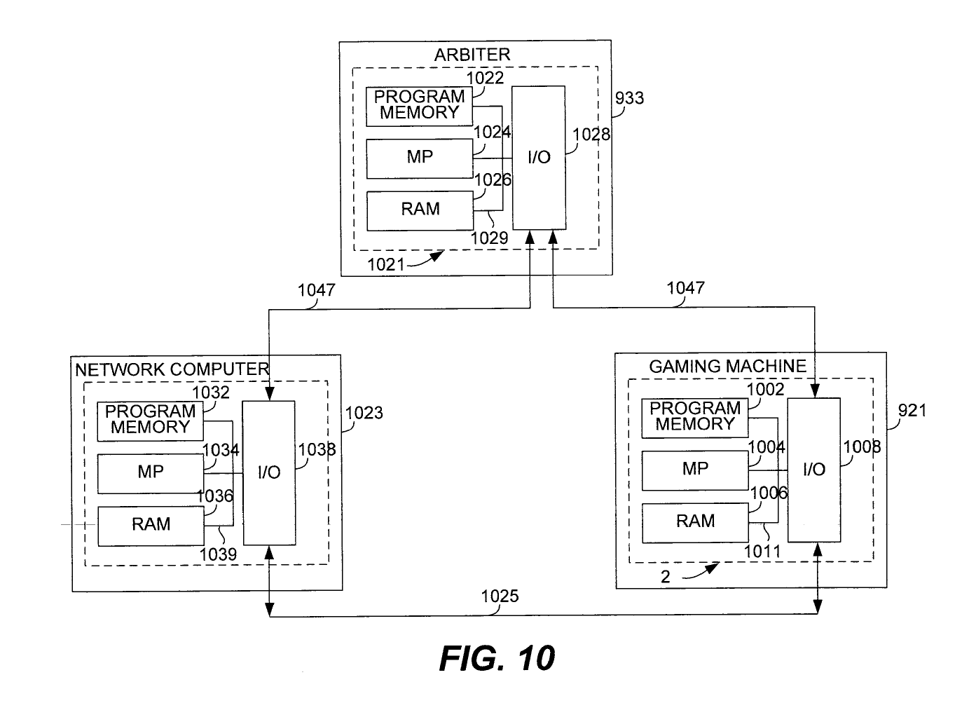

FIG. 10 is a block diagram of a simplified communication topology between gaming machine 921, network computer 1023 and Arbiter 933. Network computer 1023 may be, for example, a server or other device within computer room 920 or elsewhere. Although only one gaming machine 921, one network computer 1023 and one Arbiter 933 are shown in FIG. 10, it should be understood that the following examples may be applicable to different types of networked devices in addition to gaming machine 921 and network computer 1023, and may include different numbers of network computers 1023, Arbiters 933 and gaming machines 921. For example, a single Arbiter 933 may be used for secure communications among a plurality of network computers 1023 and tens, hundreds or thousands of gaming machines 921. Likewise, multiple Arbiters 933 may be utilized for improved performance and other scalability factors.

Referring to FIG. 10, the Arbiter 933 may include an arbiter controller 1021 that may comprise a program memory 1022, a microcontroller or microprocessor (MP) 1024, a random-access memory (RAM) 1026 and an input/output (I/O) circuit 1028, all of which may be interconnected via an address/data bus 1029. The network computer 1023 may also include a controller 1031 that may comprise a program memory 1032, a microcontroller or microprocessor (MP) 1034, a random-access memory (RAM) 1036 and an input/output (I/O) circuit 1038, all of which may be interconnected via an address/data bus 1039. It should be appreciated that although the Arbiter 933 and the network computer 1023 are each shown with only one microprocessor 1024, 1034, the controllers 1021, 1031 may each include multiple microprocessors 1024, 1034. Similarly, the memory of the controllers 1021, 1031 may include multiple RAMs 1026, 1036 and multiple program memories 1022, 1032. Although the I/O circuits 1028, 1038 are each shown as a single block, it should be appreciated that the I/O circuits 1028, 1038 may include a number of different types of I/O circuits. The RAMs 1024, 1034 and program memories 1022, 1032 may be implemented as semiconductor memories, magnetically readable memories, and/or optically readable memories, for example.

Although the program memories 1022, 1032 are shown in FIG. 10 as read-only memories (ROM) 1022, 1032, the program memories of the controllers 1021, 1031 may be a read/write or alterable memory, such as a hard disk. In the event a hard disk is used as a program memory, the address/data buses 1029, 1039 shown schematically in FIG. 10 may each comprise multiple address/data buses, which may be of different types, and there may be an I/O circuit disposed between the address/data buses.

As shown in FIG. 10, the gaming machine 921 may be operatively coupled to the network computer 1023 via the data link 1025. The gaming machine 921 may also be operatively coupled to the Arbiter 933 via the data link 1049, and the network computer 1023 may likewise be operatively coupled to the Arbiter 933 via the data link 1047.

Communications between the gaming machine 921 and the network computer 1023 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), download information (e.g., game and/or peripheral software, licensing information, etc.) and personal information (e.g., social security number, personal preferences, etc.) may be encrypted with stronger encryption techniques such as DES or 3DES to provide increased security.

As disclosed in further detail in the Arbiter Application, the Arbiter 933 may verify the authenticity of devices in the gaming network, including but not limited to devices sending queries and/or remote procedure calls to gaming machines. The Arbiter 933 may receive a request for a communication session from a network device. For ease of explanation, the requesting network device may be referred to as the client, and the requested network device may be referred to as the host. The client may be any device on the network and the request may be for a communication session with any other network device. The client may specify the host, or the gaming security arbiter may select the host based on the request and based on information about the client and potential hosts. The Arbiter 933 may provide encryption keys (session keys) for the communication session to the client via the secure communication channel. Either the host and/or the session key may be provided in response to the request, or may have been previously provided. The client may contact the host to initiate the communication session. The host may then contact the Arbiter 933 to determine the authenticity of the client. The Arbiter 933 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, the Arbiter 933 may contact the host regarding the request and provide corresponding session keys to both the client and the host. The Arbiter 933 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

Referring again to FIG. 9, the communication link(s) between casino 905 and central system 963 preferably have ample bandwidth and may, for example, comprise one or more T1 or T3 connections and/or satellite links having comparable bandwidth, etc. Network 929 is the Internet in this example. However, it will be understood by those of skill in the art that network 929 could include any one of various types of networks, such as the public switched telephone network (“PSTN”), a satellite network, a wireless network, a metro optical transport, etc. Accordingly, a variety of protocols may be used for communication on network 929, such as Internet Protocol (“IP”), Fibre Channel (“FC”), FC over IP (“FCIP”), Internet SCSI (“iSCSI,” an IP-based standard for linking data storage devices over a network and transferring data by carrying SCSI commands over IP networks) or Dense Wavelength Division Multiplexing (“DWDM,” an optical technology used to increase bandwidth over existing fiber optic backbones).

If a host device is located in a remote location, security methods and devices (such as firewalls, authentication and/or encryption) should be deployed in order to prevent the unauthorized access of the gaming network.

Similarly, any other connection between gaming network 905 and the outside world should only be made with trusted devices via a secure link, e.g., via a virtual private network (“VPN”) tunnel. For example, the illustrated connection between sb™ server 930, gateway 950 and central system 963 (that may be used for communications involving peripheral device software downloads, etc.) is advantageously made via a VPN tunnel. Details of VPN methods that may be used with the present invention are described in the reference, “Virtual Private Networks-Technologies and Solutions,” by R. Yueh and T. Strayer, Addison-Wesley, 2001, ISBN#0-201-70209-6, which is incorporated herein by reference and for all purposes. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including RFC reports, may be obtained from the VPN Consortium, an industry trade group (http://www.vpnc.com, VPNC, Santa Cruz, Calif.).

Alternatively, a permanent virtual circuit (“PVC”) can be established to provide a dedicated and secure circuit link between two facilities, e.g., between a casino and central system 963. A PVC is a virtual circuit established for repeated use between the same data terminals. A PVC could be provided, for example, via AT&T's Asynchronous Transfer Mode (“ATM”) switching fabric. Some implementations provide a dedicated line from an endpoint (e.g., from casino 905) into the ATM backbone. Other implementations provide a connection over another network (e.g., the Internet) between an endpoint and the nearest device of the ATM backbone, e.g., to the nearest edge router. In some such implementations, the fixed-sized cells used in the ATM switching fabric may be encapsulated in variable sized packets (such as Internet Protocol or Ethernet packets) for transmission to and from the ATM backbone.

For security purposes, information transmitted to, on or from a gaming establishment may be encrypted. In one implementation, the information may be symmetrically encrypted using a symmetric encryption key, where the symmetric encryption key is asymmetrically encrypted using a private key. The public key may, for example, be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

Some network implementations may use Trusted Network Connect (“TNC”), which is an open architecture provided by the Trusted Network Connect Sub Group (“TNC-SG”) of the Trusted Computing Group (TCG). TNC enables network operators to provide endpoint integrity at every network connection, thus enabling interoperability among multi-vendor network endpoints. Alternatively, or additionally, the Secure Internet File Transfer (“SIFT”) may be employed. SIFT allows devices to send and receive data over the Internet in a secure (128-bit encryption) method of transport.

Providing secure connections between devices in a gaming network, such as the connections between the local devices of the gaming network 905 and central system 963, allows for the deployment of many advantageous features. For example, a customer (e.g., an employee of a gaming establishment) may be able to log onto an account of central system 963 to obtain the account information such as the customer's current and prior account status. Automatic updates of a customer's software may also be enabled. For example, central system 963 may notify one or more devices in gaming establishment 905 regarding new products and/or product updates. For example, central system 963 may notify server (or other device) in computer room 920 regarding new software, software updates, the status of current software licenses, etc. Alternatively, such updates could be automatically provided to a server in computer room 920 and downloaded to networked gaming machines.

After the local server receives this information, relevant products of interest may be identified (by the server, by another device or by a human being). If an update or a new software product is desired, it can be downloaded from the central system. Similarly, a customer may choose to renew a software license via a secure connection with central system 463, e.g., in response to a notification that the software license is required.

In addition, providing secure connections between different gaming establishments can enable alternative implementations of the invention. For example, a number of gaming establishments may be owned and/or controlled by the same entity. In such situations, having secure communications between gaming establishments makes it possible for a gaming entity to use one or more servers in a gaming establishment as an interface between central system 963 and gaming machines in multiple gaming establishments. For example, new or updated software may be obtained by a server in one gaming establishment and distributed to gaming machines in that gaming establishment and/or other gaming establishments. A server in one gaming establishment may perform services, such as patron identification services, in response to a request from a device in another gaming establishment.

Some implementations of the invention involve aggregating data involving multiple patrons. In some such implementations, such data aggregations are used to determine patron “traffic patterns” and the like, including but not limited to determining what games targeted patrons prefer to play and when they prefer to play them. These data may be used to determine what games to enable in a given part of the casino during a given time period, thereby more nearly optimizing the deployment of games on the casino floor. By combining game preference data with patron preference and/or demographic data, offers and advertisements for the gaming, retail, beverage, restaurant, club and entertainment sectors of a gaming establishment may be more optimally directed to patrons of interest.

Some methods of the invention combine information that can be obtained from one or more gaming establishment databases with some of the SBG features described above. By combining, for example, information regarding scheduled gaming machine configurations and information regarding the amount of money that a gaming machine brings in while a gaming machine has a particular configuration, gaming machine configurations may be optimized to maximize revenue. Some such methods involve determining a first rate of revenue obtained by a gaming machine in the gaming network during a first time when the gaming machine has a first configuration. The gaming machine is later automatically configured according to second configuration information supplied by the SBG server, e.g., as scheduled by the Scheduler. A second rate of revenue, obtained by the gaming machine during a second time when the gaming machine has the second configuration, is determined, and so on.

After scheduling various configurations at various times, optimum configurations for the gaming machine may be determined for various times of day. The SBG system can them provide scheduled optimal configurations for the gaming machine at the corresponding times of day. Some implementations provide for groups (e.g., banks) of gaming machines to be automatically configured according to a predetermined schedule of optimal configurations for various times of day, days of the week, times of the year, etc.

In some such implementations, an average revenue may be computed, based on revenue from many gaming machines having the same configuration at the same time of day. These average revenues could be used to determine an overall optimal value for relevant time periods.

Some implementations of the invention control a gaming network in response to observed revenue obtained by gaming machines during different times and/or with different configurations. One such method includes these steps: determining a first rate of revenue obtained by a first gaming machine of a plurality of gaming machines in the gaming network during a first time when the first gaming machine has a first configuration; transmitting second configuration information to the first gaming machine via the gaming network; configuring the first gaming machine with a second configuration according to the second configuration information; and determining a second rate of revenue obtained by the first gaming machine during a second time when the first gaming machine has the second configuration.

The step of determining the first rate of revenue may involve receiving first revenue data from the first gaming machine via the gaming network, the first revenue data pertaining to the first time. In some implementations of the invention, when it is determined that the first rate of revenue is higher than the second rate of revenue, the method further comprises these steps: transmitting third configuration information to the first gaming machine via the gaming network; and configuring the first gaming machine with a third configuration according to the second configuration information. The second configuration information may be, for example, denomination information, display information, pay table percentage and/or game software information.

Another such method involves these steps: receiving revenue data from a first gaming machine of a plurality of gaming machines in the gaming network; determining a first rate of revenue obtained by the first gaming machine during a first time when the first gaming machine has a first configuration; determining a second rate of revenue obtained by the first gaming machine during a second time when the first gaming machine has a second configuration; determining an N^{th} rate of revenue obtained by the first gaming machine during an N^{th} time when the first gaming machine has an N^{th} configuration; and ascertaining a first optimum configuration for the first gaming machine during a first time of day. The first optimum configuration corresponds with a highest rate of revenue determined for the first gaming machine during the first time of day.

The method may also involve scheduling the first gaming machine to be automatically configured with the first optimum configuration during the first time of day. If the first gaming machine is part of a bank of gaming machines, the method may involve scheduling each gaming machine of the bank of gaming machines to be automatically configured with the first optimum configuration during the first time of day.

The method may include these steps: ascertaining a second optimum configuration for the first gaming machine during a second time of day, the second optimum configuration corresponding with a highest rate of revenue determined for the first gaming machine during the second time of day; and scheduling the first gaming machine to be automatically configured with the second optimum configuration during the second time of day.

The method may include the following steps: receiving revenue data from second through M^{th} gaming machines in the gaming network; determining a first average rate of revenue obtained by the second through M^{th} gaming machines during the first time when the second through M^{th} gaming machines have the first configuration; determining a second average rate of revenue obtained by the second through M^{th} gaming machines during a second time when the second through M^{th} gaming machines have a second configuration; determining an N^{th} average rate of revenue obtained by the second through M^{th} gaming machines during an N^{th} time when the second through M^{th} gaming machines have an N^{th} configuration; and ascertaining a first overall optimum configuration for the second through M^{th} gaming machines during a predetermined time of day. The first overall optimum configuration corresponds with a highest average rate of revenue determined for the second through M^{th} gaming machines during the predetermined time of day. The first optimum configuration may include a denomination, a display type, a pay table percentage and/or a game type.

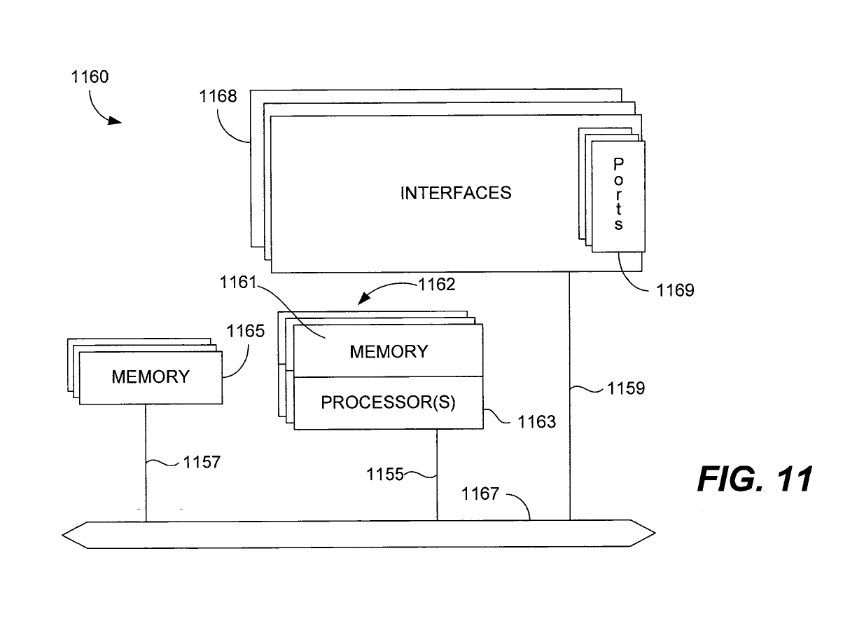

FIG. 11 illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 11 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 11) or switch fabric based (such as a cross-bar).

While this invention is described in terms of preferred embodiments, there are alterations, permutations, and equivalents that fall within the scope of the invention. It should also be noted that there are many alternative ways of implementing the present invention. It is therefore intended that the invention not be limited to the preferred embodiments described herein, but instead that the invention should be interpreted as including all such alterations, permutations, and equivalents as fall within the true spirit and scope of the present invention.

For example, some implementations of the invention provide for the aggregation of patron data, including patron event data, according to selected patron categories. Patron data that is stored for individual patrons may be analyzed to determine characteristics of patrons in a similar category, e.g., a similar age range, player loyalty program level, wager gaming characteristics (e.g., game type preference, wager/denomination level, volatility preferences, etc.), favorite beverage (e.g., beer drinkers, wine drinkers, Scotch drinkers, Cosmo drinkers), level of retail spending, level of food and/or beverage spending, etc. Such characteristics may be used for various purposes, e.g., for predictive modeling of future events, to make an educated guess regarding the preferences of a patron for whom relatively little is known, etc.

Depending on the amount of data to be evaluated and potentially stored regarding patrons, it may be advantageous to store data in a dimensional database structure. Multi-dimensional database achieve performance levels that are well in excess of that of relational systems performing similar data storage requirements. These high performance levels encourage and enable On Line Analytical Processing (“OLAP”) and other such applications that can provide the ability to analyze large amounts of data with very fast response times.

1. An image analyzing system comprising:
a plurality of cameras for obtaining patron data regarding patrons in or near a gaming establishment, at least some cameras being configured for automated patron tracking, the cameras configured for communication with other devices via a network; and
a server, comprising:
at least one network interface configured for communication with the network;
a memory system comprising at least one memory device having a rule set of defined events stored thereon; and
a logic system configured to do the following:
acquire video data from at least one of the cameras via the network interface, the video data comprising patron data;
determine, with reference to the rule set, whether the patron data comprise defined event data; and
categorize patrons according to the determination.

2. The system of claim 1, wherein the system comprises means for tracking a patron who moves from a first field of view of a first camera to a second field of view of a second camera.

3. (canceled)

4. The system of claim 1, wherein the logic system is further configured to receive descriptive data regarding a patron and associate the descriptive data with the video data.

5. The system of claim 1, wherein the logic system is further configured to determine when to hand off tracking of a patron from a first camera to a second camera.

6. The system of claim 1, wherein the logic system is further configured to determine a characteristic display type for a patron category.

7. The system of claim 1, wherein the logic system is further configured to determine a patron location.

8. The system of claim 1, further comprising at least one host device configured for communication with the network.

9. The system of claim 1, wherein at least some cameras are configured to determine whether the patron data comprise defined event data.

10. The system of claim 1, wherein at least some cameras are configured to automatically generate descriptive data according to patron data.

11. The system of claim 8, wherein the host device is configured to display video data from at least one camera.

12. The system of claim 11, wherein the host device is configured to display patrons according to patron categories.

13. The system of claim 11, wherein the host device is configured to receive an indication of a selected patron from a user.

14. The system of claim 12, wherein the host device is configured to display a patron according a characteristic color or shape associated with a patron category.

15. The system of claim 13, wherein the host device is configured to receive an indication to view previously-acquired patron data regarding the selected patron and to transmit a request to view the previously-acquired patron data to the server.

16. The system of claim 15, wherein the server is further configured to receive the request, to retrieve previously-acquired patron data for the selected patron and to transmit the previously-acquired patron data to the host device.

17. The system of claim 15, wherein the previously-acquired patron data comprise video data.

18. The system of claim 15, wherein the previously-acquired patron data comprise descriptive data.

19. The system of claim 15, wherein the previously-acquired patron data comprise patron location data.

20-36. (canceled)
